(19) United States
(12) Patent Application Publication
(10) Pub. No.: US 2009/0158246 A1
(43) Pub. Date: Jun. 18, 2009

(54) METHOD AND SYSTEM FOR BUILDING TRANSACTIONAL APPLICATIONS USING AN INTEGRATED DEVELOPMENT ENVIRONMENT

(75) Inventors: Daniel J. Sifter, San Francisco, CA (US); Jonathon C. Pile, Foster City, CA (US); Joseph S. Fontaine, San Francisco, CA (US); Mark Phillips, San Jose, CA (US)

Correspondence Address: Beyer Law Group LLP, P.O. BOX 1687, Cupertino, CA, 95015-1687, US

(73) Assignee: KABIRA TECHNOLOGIES, INC., SAN MATEO, CA (US)

(21) Appl. No.: 11/959,333

(22) Filed: Dec. 18, 2007

(51) Int. Cl. G06F 9/44

(52) U.S. Cl. 717/105; 717/104

(57) ABSTRACT

A transaction processing development methodology employs a transaction processing development framework to facilitate development of a desired transaction processing application. A plurality of service adaptors are provided. An infrastructure is provided via which a user defined business logic of the desired transaction processing application may be provided to the transaction processing development framework. The business logic definition is processed to instantiate the transaction processing application, including, instantiating a subset of the service adaptors to implement services of the transaction processing application, and further including arranging the instantiated service adaptors to accomplish the business logic in conjunction with generic transaction processing logic. The arrangement of service adaptors is guaranteed, when executed, to accomplish the transaction processing application in a manner that is fully transactional.

### BACKGROUND

The desire for high-volume, real-time transaction processing environments is well-known, for organizations such, as, stock brokerages, credit card processing facilities and online reservation systems. For example, from an operational point of view, “transactions” may include sales orders, credit card transactions or accounting journal entries. From a software point of view, transactions may include, for example, database transactions of the sort that keep information in a consistent form.

High-performance transaction processing used to be a rare phenomenon, utilized only in extreme environments by the largest companies. But in recent years, the Internet has opened the door to the arrival of global customers in quantity through e-commerce sites, call centers, and other forms of direct interaction. Business-to-business relationships are intermediated by direct computer-to-computer interaction, frequently based on Web services. Content delivery and mediation for services must take place in real-time. This bulge in transaction traffic follows the same pattern that has transformed the telecommunications industry from a few providers of old-style, fixed local and long distance calling services into a competitive field of real-time enterprises offering wireless mobile plans for delivery of complex, combined data, voice and video content.

The requirements of global and real-time transaction processing are becoming the norm, driving enterprises to seek out IT systems whose architectures can handle skyrocketing transaction volumes at the lowest possible cost per transaction, in a manner that allows for flexibility and agility in service offerings. Flexibility, high performance and low cost constitute a new transaction-processing triangle that confounds solutions and architectures designed on proprietary systems as recently as a decade ago.

As an example, we briefly describe a “then” and “now” example summary of transaction processing in the telecom industry. In the example, previously, one call data record (CDR) was written when a call started and one when a call ended. CDR records were used at the end of the month to create a bill for the customer. Thus, batch processing of CDR's was very adequate. Revenue-per-call could be relatively high, and the business model and service offering typically remained static for years.

Currently, multiple vendors or carriers are involved in each cell phone call. Each involved vendor or carrier tracks activity and grants permissions. The transaction volume has exploded such that, for example, each call may generate as many as one hundred CDR's to track various transactions. The number of services has grown from a simple voice call to text messaging, internet access, video, real-time data and special purpose e-commerce functions. The approval to use a service should be granted in real-time. As for revenue and business model, the revenue-per-transaction may typically be measured in cents or even micro-cents, and business models and service offerings change frequently.

Current transaction processing platforms have various disadvantages. High-availability hardware systems such as HP Non-Stop, IBM's CICS and Base24 are high volume, but are not low-cost or flexible. Specialized transaction processing systems like BEA Tuxedo are medium-volume, cheaper than high-availability systems, but are not flexible. Application servers such as J2EE/JTS may be less expensive than high-availability hardware systems and specialized transaction processing systems, and are flexible. However, these application servers are not high-performance, nor are they highly available.

In attempts to meet the current demands of transaction processing, some vendors are merging specialized transaction processing systems with application servers or installing application servers on highly available hardware, and so forth. Almost none of these attempts have been successful. Other vendors have sought to address the issues on an architectural level, by combining the flexibility offered by service-oriented architecture (SOA) with the increased automation and decoupled nature of event-driven architecture (EDA). SOA-based solutions are delivered as sets of services that can be combined and recombined to meet new requirements. Using EDA, solutions are increasingly automated, bringing in human intervention only when an exception arises that is beyond the scope of an automated solution. However, such solutions have, in general, still failed to consistently provide features such as high data access speed, flexible logic, high-speed transport and dynamic routing of Enterprise Application Integration (EAI) middleware, high transaction processing speed and resilience and fault tolerance.

### SUMMARY

A transaction processing development methodology employs a transaction processing development framework to facilitate development of a desired transaction processing application. A plurality of service adaptors are provided. An infrastructure is provided via which a user defined business logic of the desired transaction processing application may be provided to the transaction processing development framework. The business logic definition is processed to instantiate the transaction processing application, including, instantiating a subset of the service adaptors to implement services of the transaction processing application, and further including arranging the instantiated service adaptors to accomplish the business logic in conjunction with generic transaction processing logic. The arrangement of service adaptors is guaranteed, when executed, to accomplish the transaction processing application in a manner that is fully transactional.

### BRIEF DESCRIPTION OF THE DRAWINGS

FIG. 1 provides a general illustration of parts of an example processing engine, which may be considered the fundamental unit of deployment of a transaction processing platform.

FIG. 2 illustrates an example of a high-speed channel adaptor framework.

FIG. 3 illustrates nodes as a collection of processing engines working together on one area of shared memory, which plays the role of a database.

FIG. 4 illustrates messages being spread across the nodes by a special processing engine called a distribution engine

FIG. 5 schematically illustrates an example of a solution architecture.

FIG. 6 illustrates, from a different point of view, how a message may move through the transaction processing platform.

FIG. 7 illustrates an example of more detail of a message mapping by message mapper logic.

FIG. 8 schematically illustrates a multi-node deployment of business process components of a transaction processing platform, such as the business process components of FIG. 6.

FIG. 9 provides more detail of an example of runtime services of the transaction processing platform.

FIG. 10 illustrates a specific example configuration of services of the transaction processing platform, to handle an electronic payment authorization request, such as a transaction in which a credit card has been presented for payment.

FIG. 11 is a sequence diagram showing a simple request/response pattern with no use of message correlation, where the response contains enough information to perform route selection to return the message to the request flow.

FIG. 12 is a sequence diagram showing a simple request/response pattern with message correlation used, where the response does not contain enough information to perform route selection to return the message to the request flow.

FIG. 13 is a taxonomy-type description where the end-user is at the top of the diagram, building a set of configurations to combine everything into a transaction processing application.

FIGS. 14-16 each show a simplified view of a typical deployment of a transaction processing solution and illustrate various routing scenarios.

FIG. 17 illustrates a system implemented by many individual flows—request, response, timeout, and error flows.

FIG. 18 illustrates a classification flow.

FIG. 19 illustrates a typical configuration of a flow, in this case, an authorization request flow.

FIG. 20 illustrates a typical configuration of an authorization response flow.

FIG. 21 schematically illustrates an example of the development methodology and environment.

FIG. 22 shows the implementation of FIG. 21 in greater detail.

FIG. 23 illustrates an example of an integrated development environment (IDE) display.

FIG. 24 illustrates an example of the canvas portion of the FIG. 23 example display in greater detail.

### DETAILED DESCRIPTION

The inventors have proposed an architecture that will provide the data access speed of an in-memory database, the flexible logic of an application server, the high-speed transport and dynamic routing of EAI middleware, the transaction processing speed of specialized systems and the resilience and fault tolerance of high-availability hardware.

A transaction processing platform is provided that is suitable for model-driven development. In this way, the complexity of high performance computing is addressed. Building a solution on such a transaction processing platform lets programmers create a model in a standard environment (such as that provided by Eclipse—see www.eclipse.org), using an “action language” to specify detailed logic including combining logic of standard services on top of a standard infrastructure. The model specifies what the system will do by describing objects and their relationships. Once the model is created, the transaction processing platform compiles that model into a transaction processing business solution.

Furthermore, for example, the solution may be optimized at every level, combining various subsystems for data management, process management, integration and configuration, and providing other key transactional services for transaction processing. This sort of optimization is simply not possible with traditional API and programming language implementation techniques.

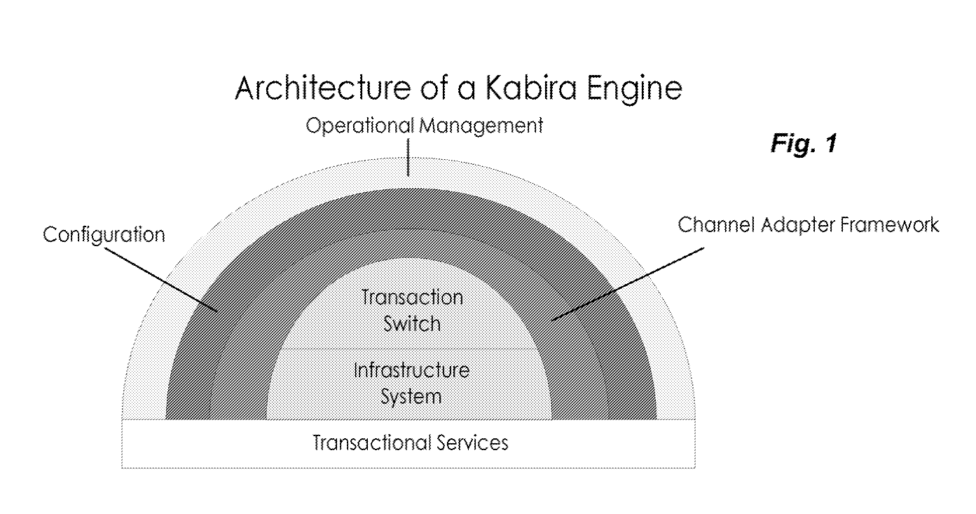

We now generally discuss how the transaction processing platform, in one example, is engineered to enable businesses to more easily offer a stream of evolving high-quality services in the marketplace, at a fraction of the cost of the alternatives. In accordance with this example, the architecture of the transaction processing platform establishes a fundamental set of capabilities and services that can be reused and combined in different ways to create flexible, high-performance solutions. The work of solutions developed for the transaction processing platform may be performed by the following elements:
infrastructure system: the part of the platform focused on data management and transactions
transaction switch: the part of the platform focused on process and flow management
channels: a high-speed adapter framework to data into the platform from external sources and to send and receive data out of the platform, such as through a stream of messages
configuration management: the part of the platform that provides an abstraction of the system landscape
operations management: the part of the platform that monitors real-time operations and allows a solution to be dynamically reconfigured
transactional services: specialized elements such as deadlock detection, mirroring, caching, pooling, transactional replication, memory management and routing functionality used to create high-performance transaction processing systems.
   The application model dictates how each of these platform elements is combined and optimized. FIG. 1 provides a general idea of how these parts may fit together into an example processing engine, which may be considered the fundamental unit of deployment. The configuration layer and operational management layers do similar jobs as the same layers in other software, providing ways to allow the process to be useful for different situations by changing configurations. Some details of both of these layers will be discussed later.

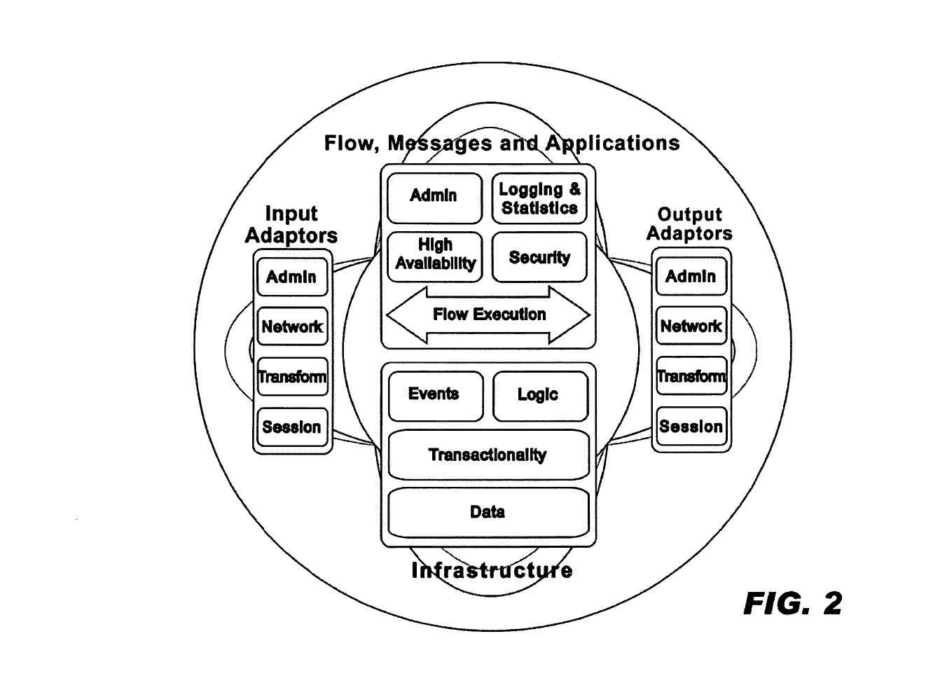

FIG. 2 illustrates an example of a high-speed channel adaptor framework. The high-speed channel adapter framework is configured to move data in and out of the transaction switch and infrastructure system. In some examples, all data in the transaction switch and infrastructure system layers is stored in shared memory, and is normalized to a standard format. All of the logic and processing that converts data to and from this standard format may be localized to the channel adapters, which can ensure that the application will not have to be modified to function with a new (or newer version) of a communication protocol, for example. A channel adaptor for that protocol would be utilized to function with the communication protocol. Furthermore, in some examples, channel adapters are modeled, rather than coded, using traditional programming languages. This allows the compiler to analyze and optimize the data transformations that take place in the adapters.

The transaction switch layer is a real-time application server focused on process management. When an application is modeled using Eclipse, for example, a series of objects is created and the behavior of the objects and the interactions between the objects are described in the model. To automate a business process, information flows from one object to another and the state of the process is maintained. In one example, to take advantage of modern hardware that allows for the execution of many simultaneous threads, the process flows in a model are analyzed to determine which parts of the process are parallel and which are serial. The transaction switch layer performs this analysis and then provides all the “plumbing” to synchronize parallel execution when possible.

The infrastructure layer can be thought of as a real-time application server focused on data management and transactions. When thousands of transactions per second are streaming through the engines in a node, the shared memory acts as a database. Each engine is running multiple threads and each engine is a separate, multi-threaded process; access to the data is strictly controlled to keep the data consistent. It is also desired, however, that all processing proceed as quickly as possible. The infrastructure layer provides the locking, event procession, data replication, and synchronization mechanisms used to turn shared memory into a high-speed repository for transaction processing. Transactional services include utility functionality for the high-speed transaction processing platform, such as real-time loading of components in engines, to error reporting.

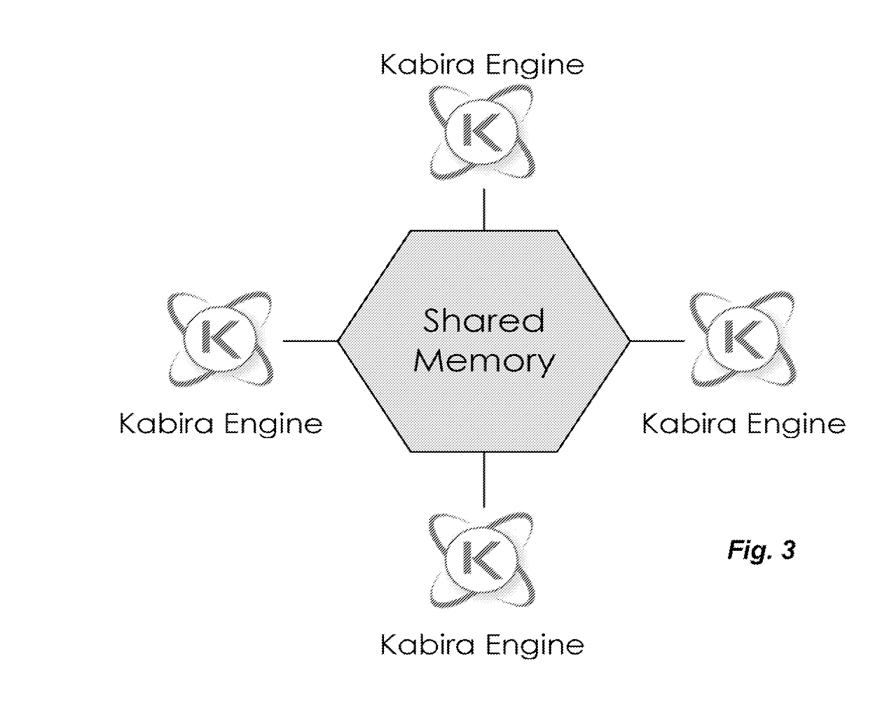

Solutions built on the transaction processing platform architecture may feature the following structure:
Components (such as objects, adapters, utilities, and so forth) are modeled in UML and combined to create an engine such as that schematically illustrated in FIG. 1.
Engines communicate to the outside world using channel adapters that send and receive messages, process data using components, and store and retrieve data from shared memory. Each engine is multi-threaded and runs in its own process (such as a UNIX process).
Configuration information is used by an engine to determine sources and destinations for messages.
Nodes are a collection of engines working together on one area of shared memory, which plays the role of a database (as shown in FIG. 3). Any number of engines, each playing similar or different roles, can be part of a node.

The channel adaptor framework may be thought of as the integration workhorse of the transaction processing platform. Like many transaction platforms, information passes to and from the engine in the form of messages. Even when external APIs are used to gather information from databases or special purpose external systems, the information gathered can be considered a stream of messages. The channels are adapters built using the framework. Channels move data to and from databases and external systems of record, Web services provided by other applications, and message queues from EAI systems at very high speeds and other appropriate sources/destinations.

The channel adapter framework transforms external messages into a normalized information format used by the transaction processing platform. Modeling may be used for everything, including the construction of the channel adapters, unlike other adapter frameworks that are based on coding in languages like Java or C++. This allows for optimization of message movement to and from an engine, taking advantage of parallel processing, queue mechanisms, and other aspects of the transaction processing platform without conscious intervention by the system developers. Modeling channel adapters also increases developer productivity and decreases maintenance. Transactional writing of some data either to external databases or to files in the file system may be supported.

With the extreme transaction processing that characterizes digital enterprise today, it is extremely advantageous to have the ability to scale—perhaps exponentially—as transaction complexity and numbers of users grow. Use of the transaction processing platform permits massive and seamless scaling as business needs increase and supports both single and distributed scaling mechanisms. This can provide application designers with the flexibility to make trade-offs between cost, manageability, and redundancy. Scalability may be achieved at relatively low cost in three decisive ways. The first is the use of low-cost commodity hardware. Models used to define solutions can be compiled to run on popular flavors of UNIX, for example. The transaction processing platform may be designed to scale on both a single platform and across multiple platforms. Thus, it may be chosen to deploy the transaction processing platform on a system that fits desired processing needs: applications hosted on the transaction processing platform can be deployed on large multiprocessor machines or on many smaller machines to meet application performance requirements. Less processor-intensive or memory-intensive nodes can be deployed on low-cost hardware running Linux, for example, while nodes using the more powerful processors and large memory spaces can run naturally on the most powerful hardware.

Another way that the transaction processing platform can be used to handle rapid growth in transaction volume is to scale “up” linearly with CPUs and clock speed. The transaction processing platform may be designed to take advantage of the CPU, memory and disk resources available on its host platform. As CPUs, threads, real memory and disk space increase, the runtime may scale transparently to the application.

For example, such CPU scaling may be achieved through the use of operating system-level threading. The total number of threads used may be optimized to minimize “empty CPU cycles” caused by excessive thread context switching, thus ensuring that CPUs are kept busy performing application work, not as much on operating system housekeeping. The architecture does not just “throw threads at the problem” to simplify the implementation. In addition, the transaction processing platform in some examples does not perform global locking. Locking of shared resources may be designed to minimize lock contention. This may be accomplished by minimizing or eliminating global resources that must be locked by all threads before any work can be performed.

This vertical scalability power may be derived by consolidating data, event and logic processing into a shared memory, and the kernel-threaded event execution architecture, which gives the transaction processing platform the power to take maximum advantage of the computers on which it runs. A solution can utilize as much memory as will ever be available on a computer. Placing all of the data in memory can enable incredibly fast processing. Such unique linear vertical scalability can allow applications to scale from Proof-of-Concept to full-scale production without performance re-engineering.

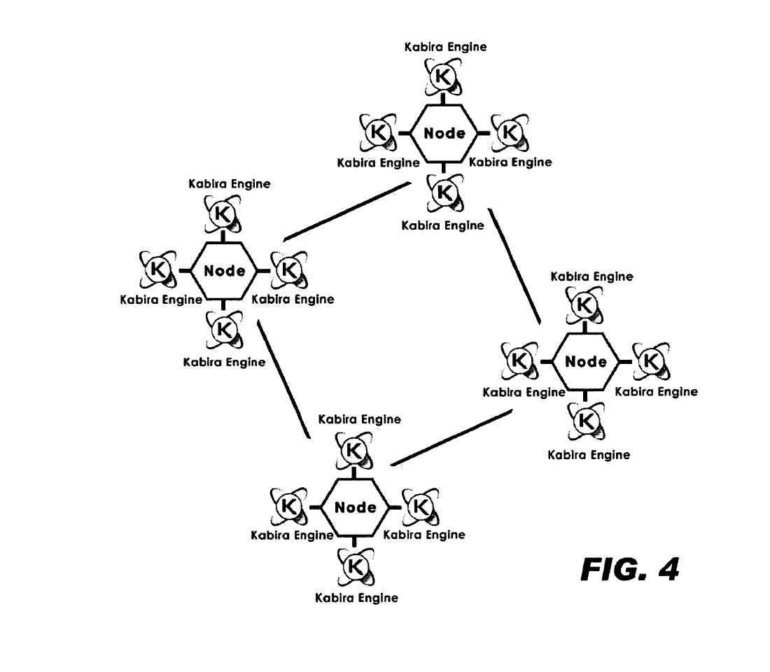

Application scaling can also occur in another way, as the architecture can be scaled “out” horizontally with the introduction of additional servers. The node architecture allows as many nodes as needed to run on as many computers as desired. The message traffic may be spread across the nodes by a special engine called a distribution engine (as shown in FIG. 4).

More specifically, a distribution engine operates to allow messages to be spread across other nodes that are running on the same computer or different computers in many different ways. For example, for a given stock-trading application, all of the ticker symbols from A to K could be on one node and the tickers from L to Z could be on another. The ability to perform dynamic configuration via a “High Availability Component” may improve the situation even further. For example, in a stock transaction processing system, if a particular stock is trading heavily, it is possible to route traffic just for that ticker to another node to better balance the load. Such rerouting can take place on the fly with, for example, no downtime.

This is in contrast with the use of middleware and database servers to deploy distributed applications; these conventionally require the applications themselves to incorporate distribution functionality. In other words, middleware and database server support for distributed applications is little more than simply transporting data from one machine to another, which is the simplest part of building distributed applications.

The HA Component may give an enterprise business system “five 9s” (99.999%) of availability without reliance upon redundant clusterware, transaction monitors or databases. Five 9s is a mainframe-class, high-speed, high traffic system that has no more than five minutes of downtime per year. The HA component provides a low-latency system, where failovers are transparent to users, there is no interruption of work, no transactions lost and backup and recovery functions occur with little or no degradation in performance. An example of the transaction processing platform implements high availability completely in software without using specialized hardware, shared or clustered disks, or redundant hardware that typically lies idle, in standby mode.

Transaction routing ensures that business applications are always available, even if there is a hardware, operating system or application failure. One aspect of highly available systems is that all data is stored in different places. Traditional highly available systems are like RAID 5 storage devices that spread data out over several disks, making sure that all data is available on at least two physical drives at all times. An example of the transaction processing platform utilizes transactional replication and mirroring functions to accomplish high availability of data.

The platform guarantees data integrity by routing each transaction to an active copy of the data. Key stateful objects can be tagged to be highly available so that in the event of a transaction failure, the High Availability Component's Message Router forces a switchover to a designated backup server, which then becomes active and assumes responsibility for completing transactions until the primary server is restored. The system continues to process every transaction in real-time, and failover is transparent to users.

Object partitions in the HA Component assure data integrity by having a single master copy of each instance and by avoiding distributed locks. The transactional part of the replication ensures that the write on the primary system is not considered complete until the replication is complete. Any node can play the role of a primary node, a backup node, or both at the same time.

The transaction processing platform also features a variety of high-availability mechanisms such as the ability to queue bursts of transactions during high-volume periods and the ability to re-process transactions that fail in the middle of a transaction.

The high-availability feature protects both data and applications. When the High Availability Component is enabled, HA and recovery logic are inherent in every application built on the transaction processing platform, providing transparent application recovery support and saving costly IT resources and time, since programmers need not write HA-aware code into each application.

The memory-resident transactions and processing ensure memory-speed recovery from failure. Moreover, high-speed rollback and recovery occurs not only for all data associated with an application, but also the current processing state at time of failure; thus, applications may restart from the last successful processing step.

The transaction processing platform, in one aspect, also features a powerful and flexible Security Component that ensures the confidentiality, integrity and security of all data and mission-critical applications deployed on the platform. Security-enabled systems perform with very high speed and efficiency because users enable security only for those operations desired to be secured—there is no performance impact to operations not desired to be secured. Endowing any application with security can be as simple as turning on the Security Component—no coding required.

The Security Component provides users with fine-grained control over rules of access, allows security functionality to be added retroactively to previously unsecured applications, and provides support for existing security technologies (such as via the Security Services Layer—SSL).

The transaction processing platform is flexible enough to handle the real world challenges of high-volume transaction processing. The transaction processing platform offers platform independence, for example, supporting Solaris, and Linux. New components can be loaded into an engine while the rest of the engine continues running. The new component can go live with virtually no impact on an operating system, allowing bug fixes or new versions to come into production without scheduled downtime.

The configuration mechanisms are similarly flexible. When an engine is loaded, the engine looks for configuration information that describes the location of other nodes to communicate with, and for external services that will be used. Configuration information can be changed on the fly. Failsafe mechanisms exist to prevent shutting down a connection to a node while the other node is still active. Configuring for High Availability, such as determining which node is going to handle which messages, is also configurable at runtime.

Uncontrolled system changes are a frequent cause of system outages. An organization should be able to build, test and deploy new versions of mission-critical applications as often as necessary—while relying on continuous systems and transaction operations. Change management functions of the transaction processing platform ensure system stability during major system changes, including during system configuration changes and when adding or deleting hardware devices from the running system. A number of reconfiguration tasks can also be controlled at the application level in order to maintain, repair or upgrade elements of a system without needing to shut down or restart.

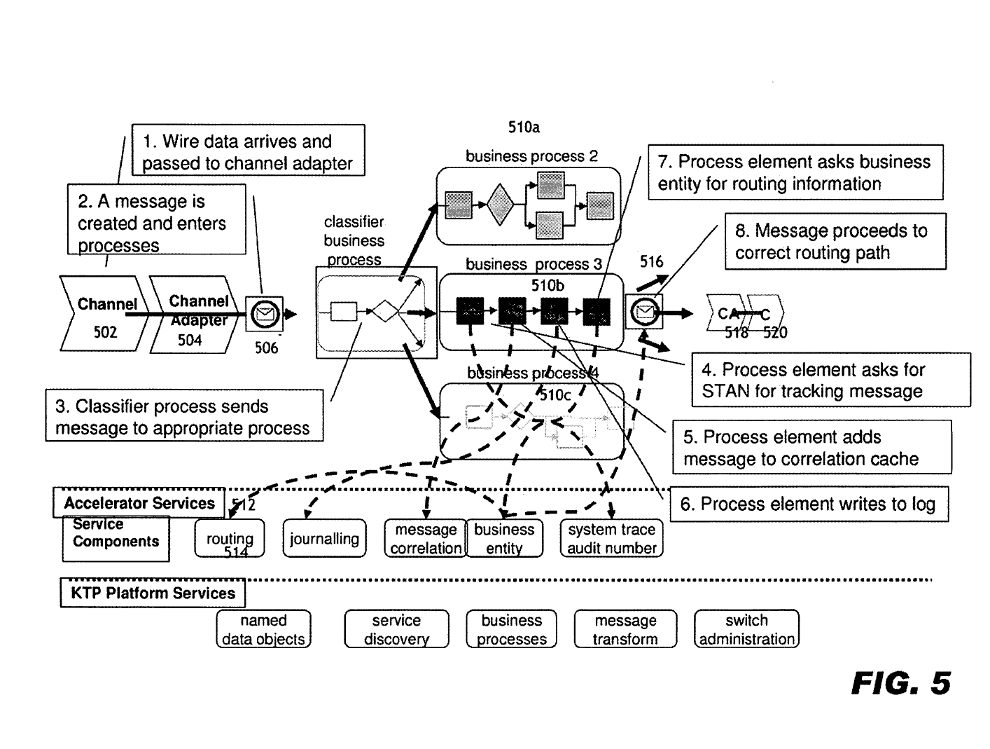

From a technical perspective, components, engines, and nodes tell the story of how the transaction processing platform architecture works, but applications and solutions built with the transaction processing platform can organize functionality in several different ways. See FIG. 5, which schematically illustrates an example of a solution architecture. Service Components are special purpose collections of components, engines, and nodes that are dedicated to executing a particular function—specific needs for a line of business. For example, a payment component may be configured to provide functionality to process electronic payments.

Solutions are enterprise software products built using the transaction processing platform. Pre-packaged solutions may be provided for payment processing, for telecommunications provisioning, and other business areas. While pre-packaged solutions are built using the model-driven technique, the pre-packaged solutions are nonetheless configurable solutions like any other enterprise software. Modeling can be used to extend the functionality of a pre-packaged solution.

In accordance with another aspect, the transaction processing platform interacts with data from systems of record containing customer or account information. The transaction processing platform is not merely a high-performance cache, using messaging and a memory-resident database. Rather, with the Channel Adapter Framework and the mechanism for transactionally storing data in various repositories, the transaction processing platform can operate as systems of record and manage important information.

For example, the transaction processing platform can interact with data in other systems in the following scenarios. For example, the transaction processing platform may be a system of record, using a persistent storage mechanism, such as a database, as a permanent repository. Any other systems that need the stored data can ask for it through message-based transactions or applications built on the transaction processing platform. The data in the permanent repository can also be replicated to any other repositories that may need to use the data on a read-only basis.

As another example, the transaction processing platform may be a high-performance cache. For example, the system of record may be the “master” and the transaction processing platform loads data from the system of record when the system is started. Then, as transactions are processed, the transaction processing platform operates to send a stream of updates back to the system of record.

As another example, the transaction processing platform may be a hybrid. In this model, the transaction processing system combines aspects of both a high-performance cache and a system of record. With respect to master data, (which changes much less frequently than transactional data), the transaction processing system may play the role of a cache and bring master data in at startup time, not updating the master data until the system is restarted or the data is scheduled for a refresh. Transactional data, particularly if being assembled from many different underlying systems, could be managed inside the transaction processing system as a system of record. Changes to the transactional data could then be distributed to the source systems in a variety of ways.

We now discuss a development methodology. A methodology for creating solutions delivers on the full promise of model-driven development. Most other development environments or products that use model-driven development offer a partial solution, presenting a visual interface for some portions of an application, even though the objects that the model is gluing together must be developed in a traditional programming language, such as Java or C++.

While partially modeled applications can improve productivity in some situations, the approach may be inadequate for high-performance computing. In a fully modeled solution—one in which all the objects and their behavior are expressed in a modeling language—a whole new world of optimization and automatic assembly of components is opened up. At compile time, the transaction processing system has a view of the entire application and can then render an implementation of that model using its understanding of threads to take advantage of parallelism and apply all of the transactional services where needed.

A result of the model-driven development may be reduction in development and implementation complexity and an increase in application quality. The power of modeling has tremendous leverage. For example, 20,000 lines of a model may result in generation of the equivalent of 2 million lines of implementation code. Models are much easier to maintain than thousands of lines of code and are less prone to error.

A model creation environment such as Eclipse provides a visual representation of the models used to create engines in the transaction processing platform. A Model-Driven Architecture (MDA) may be employed, which allows applications to be specified using a modeling language like UML or BPEL and the implementation of the application can then be generated. The model is compiled into an executable engine.

The model-driven architecture enables programmers to develop and deploy new services and network-based applications using high-level UML models, standard action language and automatically-generated Web Services, CORBA, Java or XML interfaces that are independent of underlying technology. This allows system architects to design very complex solutions in a few weeks or months, with a small team of modeling and domain experts. The resulting applications-which are compiled one hundred percent from high-level models-are supported by the transaction processing platform and executed with unprecedented speed, flexibility and scalability. Applications can automatically recover from system or runtime faults without loss of transactions or data.

Thus, the need for complex, 3GL coding can be minimized or eliminated without compromising any of the flexibility of traditional development. This enables network and transaction architects to leverage legacy applications, hardware platforms and network elements, and to focus on service delivery processes and models rather than on infrastructure requirements.

A convenient feature of examples of the transaction processing platform includes separation of configuration information from applications. The system can be configured using, for example, XML instructions, without the need for programming. The switch can also be dynamically reconfigured while the system is running to allow for new business rules and multiple versions of business rules.

Configuration files can be versioned. One version, for example, could describe the testing environment, another could describe the staging environment, and still another could describe the production environment. Certain changes may be refused, such as closing a connection from one side when the other side of the connection is still open.

Using the modeled applications environment, the model can be used to generate initial test cases. The end-point simulation and testing framework allows for the creation of proxies for external services to simulate their behavior. The testing framework also contains a mechanism for storing test data. Using this framework, the functional accuracy can be tested using pass/fail tests. The performance of the application can be analyzed under load. The performance testing features of the platform allow statistics to be gathered to assist in optimizing the model.

The transaction processing platform, in some examples, is highly configurable at run-time. Configuration changes, loading of new components and tuning of high-availability features can all take place during transaction processing without interruption.

In a hardware-based high-availability system, every part of an application runs on expensive, high-performance hardware. Even if such a configuration may make sense for the most demanding applications, it can be costly overkill in situations where smaller, cheaper computers can acceptably handle simpler tasks with sufficient speed. Each node runs on one machine. The powerful platform node architecture can run on commodity hardware, giving a choice of determining where to place nodes, based on the type of hardware each node may use to achieve optimum performance.

For example, if several nodes are sharing the burden of transaction processing, the size and expense of the hardware allocated to each node can be tuned so that each node gets the CPU and memory it needs at the lowest possible cost. For example, nodes that do not need such high performance hardware may run on lower-cost Linux-based systems.

As mentioned above, FIG. 5 illustrates an example operation of a particular implementation of a transaction processing platform—in this case, for payment processing. Referring to FIG. 5, data arrives from the network on a channel 502 and is passed to a channel adaptor 504. As discussed above (e.g., relative to FIG. 2), the channel adaptor 504 converts data from the channel into a normalized format for processing by the processes of the transaction processing platform. The channel adaptor also operates according to a communication protocol or protocols by which the data is transmitted on the network. Reference numeral 506 indicates the message in the normalized format being provided for processing.

In the FIG. 5 example, a classifier business flow 508 is provided, to determine a particular processing path based on a classification of the message 506. For example, the determined processing path may be, for example, one of business process 2 (510a), business process 3 (510b) and business process 4 (510c). In the FIG. 5 example operation, the determined processing path is business process 3 (510b). Furthermore, the processes access accelerator services service components 512. A routing service component 514 is consulted, and a resulting output message 516 (in normalized format) is provided to a channel adaptor 518. The channel adaptor 518 handles adjusting the format of the output message 516 and also operates according to a communication protocol or protocols by which the data is transmitted on the network from the channel 520.

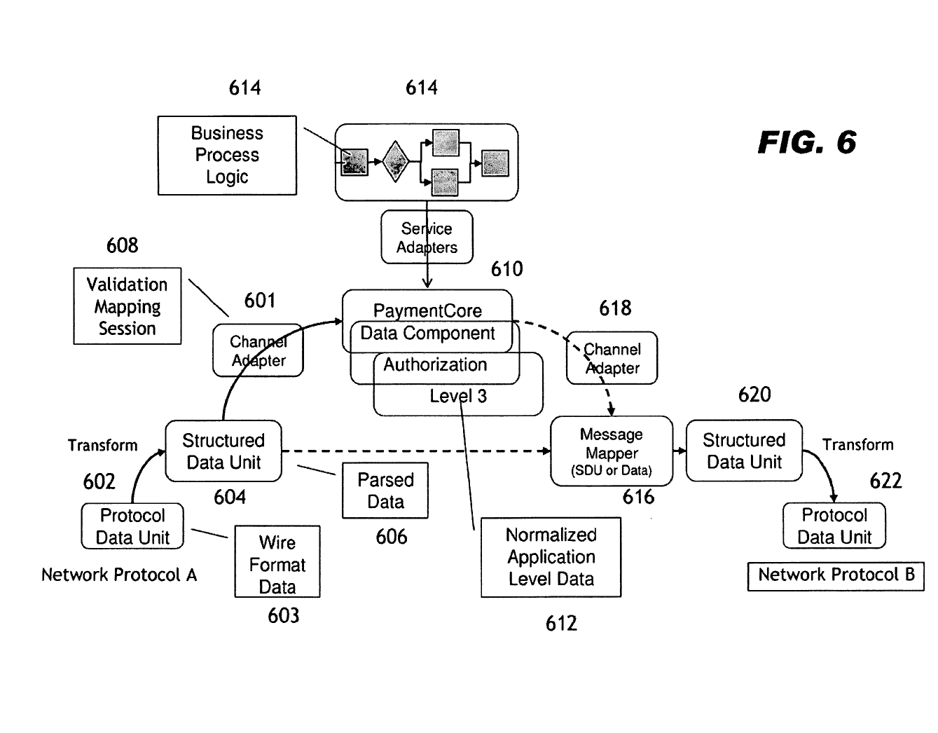

FIG. 6 illustrates, from a different point of view, how a message may move through the transaction processing platform. A channel adaptor 601 operates to input a protocol data unit 602 in a wire format 603, according to a network protocol A. The protocol data unit 602 is transformed into a structured data unit 604, including parsing data 606 from the protocol data unit 602. The channel adaptor 601 also includes validation mapping.

The structured data unit 604 is provided by the channel adaptor 601 to business process components 610. The business process components 610 operate on normalized application level data 612 of the structured data unit 604. The business process components 610 operate to implement business logic 614 with respect to the normalized application level data 612.

The business process components 610 operate in conjunction with message mapper logic 616 of a channel adaptor 618 to transform an output structured data unit 620 of the business process components 610 into a protocol data unit 622 for output by the channel adaptor 618 according to network protocol B.

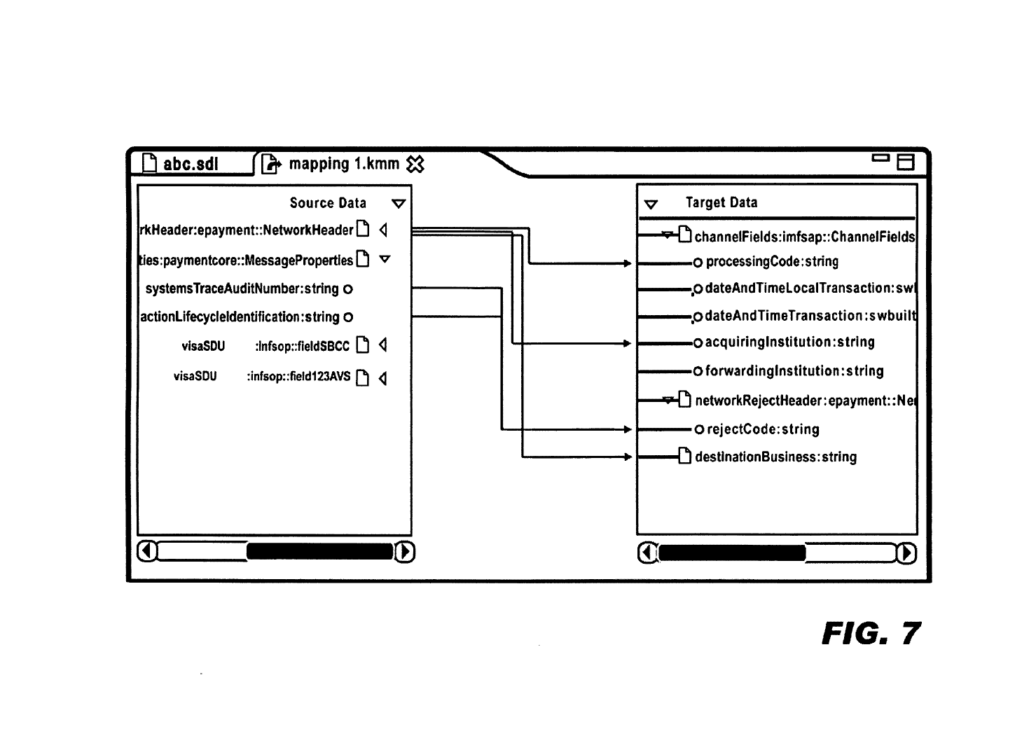

An example of more detail of a message mapping by message mapper logic 616 is now described with reference to FIG. 7. Basically, the message mapper logic 616 operates to, in one example, map between an internal, normalized, message format and a structured data unit format expected by a system with which the transaction platform is interacting. In one example, the integrated development environment operates to write a “mapping file” when a message mapping is saved. The message mapping for a particular message may be, for example, embodied in a “mapping file” containing the properties of the mapping and a list of rules for performing the mapping, including checking for errors. The mapping file is processed into executable code to perform the specified mapping.

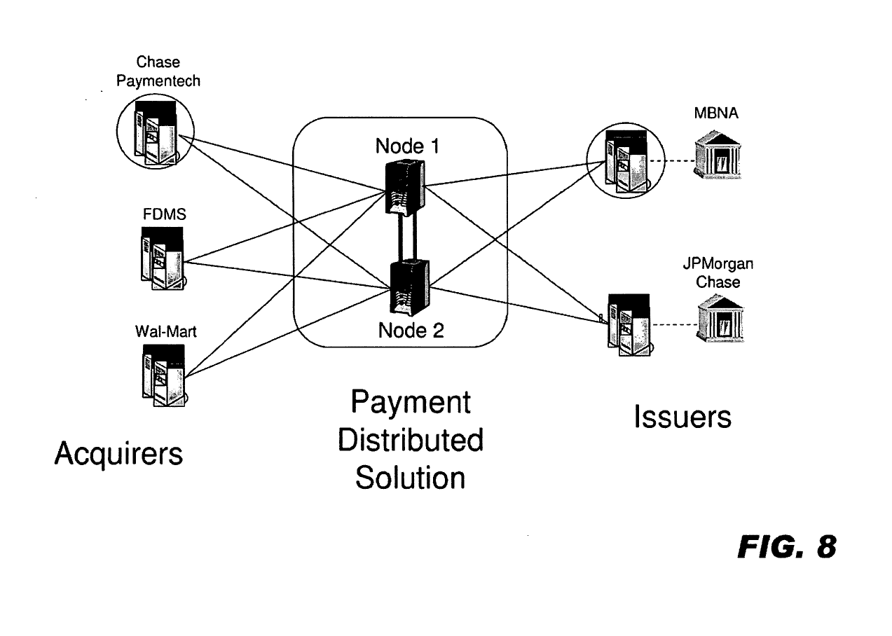

FIG. 8 schematically illustrates a multi-node deployment of business process components of a transaction processing platform, such as the business process components 610 shown in FIG. 6, for example. Thus, for example, the nodes of a multi-node deployment may participate in active/active or active/standby modes to provide application-level fail-over services.

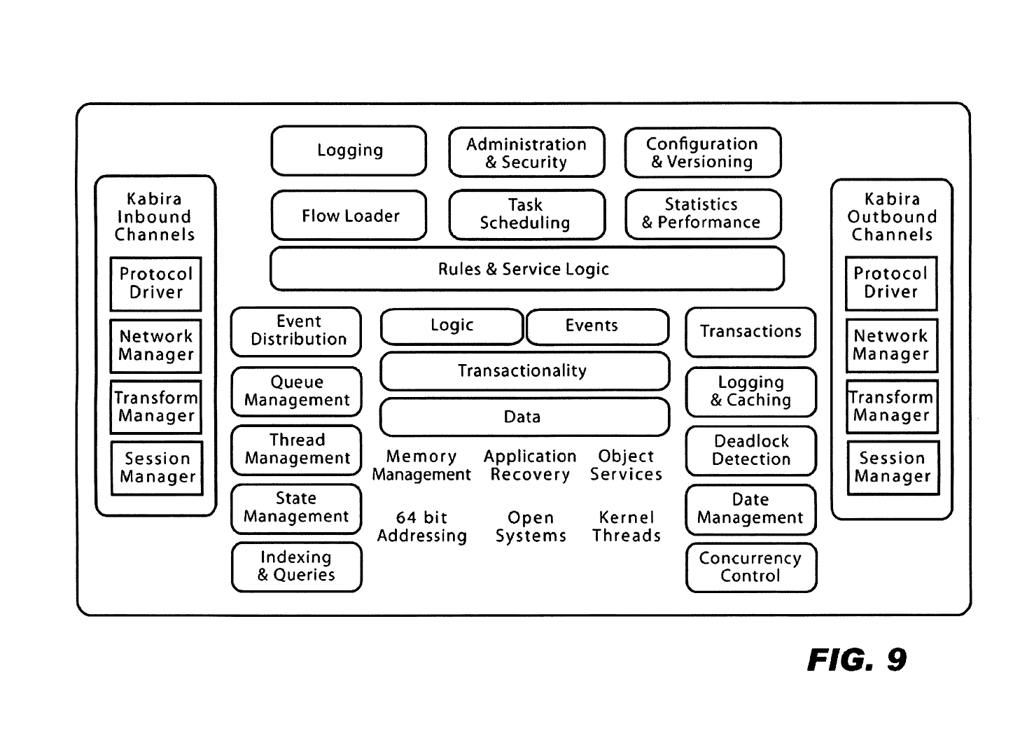

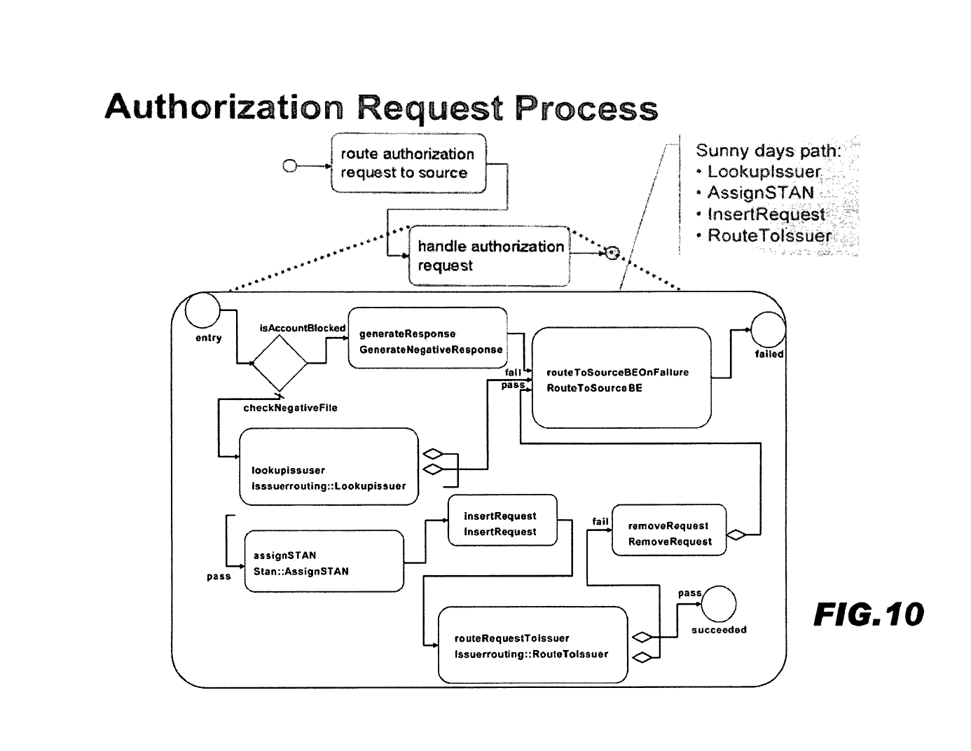

FIG. 9 provides more detail of an example of runtime services of the transaction processing platform, and FIG. 10 illustrates a specific example configuration of services of the transaction processing platform, to handle an electronic payment authorization request, such as a transaction in which a credit card has been presented for payment.

Routing is the act of moving a message between a source and a destination using a route. A source is the origination of a message; the destination is the logical target of the message. The physical destination for a message is usually at least a network hop away from the route destination. The source and destination of a message can be on the same or different transaction processing platform nodes. A route may be uniquely identified by a name, and a collection of routes defines a route table. There can be multiple named route tables.

Normalized messages are sent over a path once a route has been selected by the application. There can be multiple paths defined for a route. The path used may be based on path selection criteria and metrics. Path selection is performed by the routing component, as opposed to route selection, which is performed by the application. A destination address uniquely identifies a path within a route.

In one example, supported addresses are:
Node name and endpoint
Node name and flow name
HA (High Availability) partition
Channel Adaptor

Paths may be chosen based on a path selection policy and the availability of paths. For example, preference may be given to local paths, path priorities, and finally, selection within the same path priorities. If a higher priority path is not available, a lower priority path may be used. This means that path selection criteria may be locality and priority with the path metric being availability.

Other possible path selection criteria may include:
Load balancing
Best response times
Network utilization
Cost
Custom criteria

Once a route has been selected by the application, the routing service provides all of the services to deliver the message to the destination. As discussed above, the destination could be on the same node or on a different node in the network. This distinction is generally transparent to the application. A single destination can be associated with multiple routes. This is useful, for example, to allow:
Different administrative reasons for different routes
Different paths to the same destination
Different path selection policies

In one example, the routing service does not support store-and-forward routing, meaning that all routing is done point-to-point between nodes. That is, in such an example, all routing is static, or source routing, with no support for dynamic, or destination routing (such as is used on the internet). In other examples, dynamic, destination routing may be employed.

We now discuss state management. Routes and paths have states. There are separate states for administrative and operational characteristics. The administrative states are:
Enabled—operator has enabled a route or path for service
Disabled—operator has removed a route or path from service
   The operational states are:
Active—route or path has connectivity and can transmit messages
Inactive—route or path has no connectivity and cannot transmit messages

Only enabled routes or paths can be active. Disabled routes and paths are always inactive.

We now present two request/response scenarios to help explain the routing functionality. The two scenarios are:
Response message contains enough information to route the response back to requestor
Response message does not contain enough information to route message back to requester. Request/response message correlation is used to determine how to route the response back to the requester.

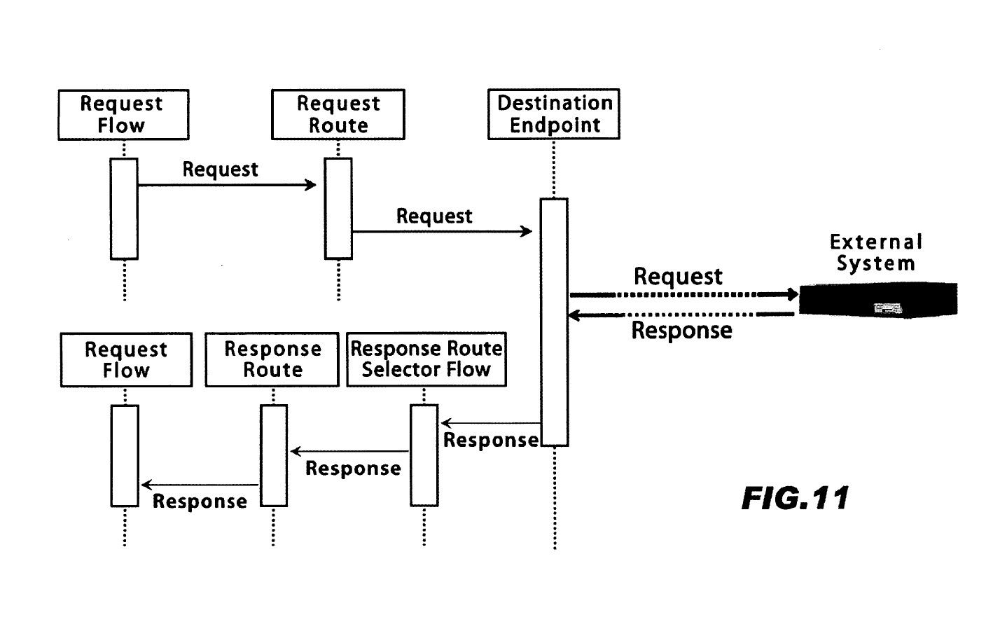

The sequence diagram in FIG. 11 shows a simple request/response pattern with no use of message correlation, where the response contains enough information to perform route selection to return the message to the request flow.

The following steps are taken in this sequence diagram:
a) A consumer in a request flow selects a request route to send a request to a destination endpoint.
b) The routing component delivers the request to the destination endpoint using the request route.
c) The destination endpoint sends the request over the network to an external system.
d) The external system responds to the request on the same endpoint.
e) The endpoint delivers the response to the response route selector flow.
f) A consumer in the response route selector flow uses data in the response to select the response route to return the response to the originating request flow.
g) The routing component delivers the response to the destination request flow using the response route.
   This completes this request/response scenario.

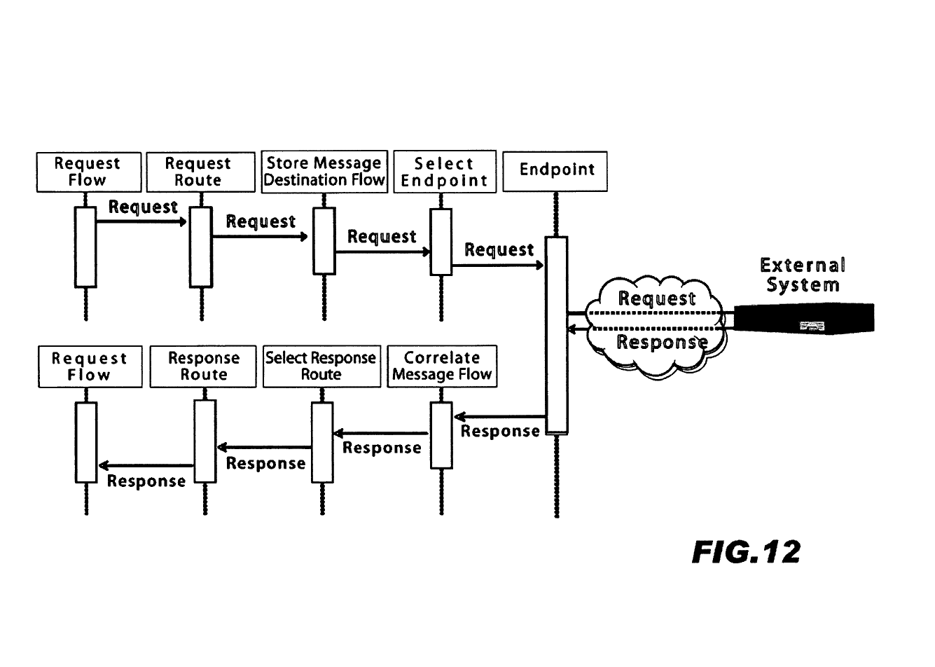

The sequence diagram in FIG. 12 shows a simple request/response pattern with message correlation used, where the response does not contain enough information to perform route selection to return the message to the request flow. In this case, the request message has been stored in a message correlation table, which is used to correlate a received response to determine the response route.

The following steps are taken in this sequence diagram:
a) A consumer in a request flow selects a request route to send a request to a destination flow.
b) The routing component delivers the request to a destination flow using the request route.
c) The destination flow stores the request in a message correlation table.
d) The endpoint is selected based on information in the request message.
e) The endpoint sends the request over the network to an external system.
f) The external system responds to the request on the same endpoint.
g) The endpoint delivers the response to the correlate message flow.
h) A consumer in the correlate message flow uses data in the response to select the original request from the message correlation table.
i) The select response route consumer uses data in the original request message to select the response route.
j) The routing component delivers the response to the destination request flow using the response route.
   This completes this request/response scenario.

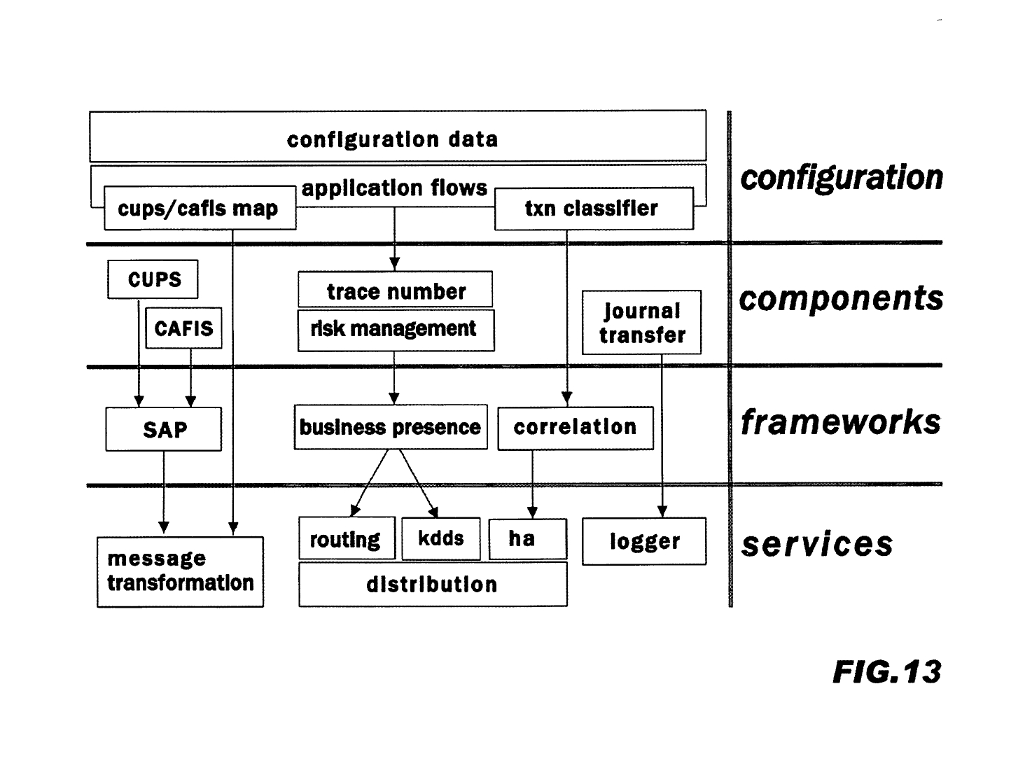

Having broadly described routing, we now more broadly describe an architecture of a system configured to handle request and response messages. We start with a taxonomy-type description, with reference to FIG. 13. Referring to FIG. 13, the end-user is at the top of the diagram, building a set of configurations to combine everything into a transaction processing application. Arrows indicate dependencies. Shaded boxes represent existing product components.

Services implement behavior for higher-level business applications. Many services will be encapsulated by higher-level solution pieces, and therefore may be hidden from the end-user. If a service is visible to the end-user, that service is typically only configurable by the end-user, not customizable e.g., message transformation as used in application flows.

A framework is a customizable component. Each framework prescribes an extensibility mechanism; higher-level pieces provide the customization and hide the details from the end-user. Some frameworks provide administration interfaces directly to the end-user (for instance, the SAP framework where SAP stands for “standard access point”).

Components are built closest to the end-user. They are configurable, but not customizable. The end-user combines pieces from all layers into a unified application with configuration data.

We now turn to a discussion of some services that may be provided.

One such service is distributed routing. The routing component encapsulates outbound and cross-node message routing decisions in a single entry point. The routing service selects the best available path within a route and delivers a message to that path. This may include routing across transaction processing nodes, if needed. Routing can deliver messages to an SAP, channel, or flow. In one example, the routing service is reachable via an API. Access to routing may be wrapped in a message consumer for flow integration. The routing service generally provides some configuration but no extensibility.

Another such service is message transformation. The transformation service provides a declarative way to map message contents from one schema to another. The transformation service may be used, for example, by SAP instances to map from a channel-specific form to a normalized message definition. The transformation service may also be used for message field validation, for example.

Transaction processing applications may also use the message transformation service to convert messages—for example, to convert between vastly dissimilar processing networks, independent of a particular channel selection.

Individual transformations may be configured in a transformation language. For example, the build process may generate a flow consumer that an application designer can simply “drop” into a flow. This is a configured service that builds a flow element.

We now discuss frameworks. The transaction processing architecture defines three significant “framework” pieces. The Business Entity framework represents one service capability of an external entity with an established presence within a transaction processing platform. Examples of a Business Entity for electronic payment transaction processing applications may include, for example:
a merchant;
a card issuer or acquirer;
a remote processing center;
a mainframe transaction processor.
   A business entity in this context typically represents a single service capability of the entity, rather than a physical or accounting role (for an electronic payment application). For example, a given electronic payments processing center may have separate applications for credit and debit transactions; this may be modeled in an electronic payment processing application as two business entities.

The business entity combines metrics, behavior, and extension points, and may include some of the functions discussed later. It is noted that the business entity framework generally does not contain much data. This may be, rather, a flexible container for customer-specific objects, as determined by the application.

A Business Entity may provide a single way to combine customized application data, partitioned by customer. It may also define a single state transition notifier to simplify development of application services using this data. Many value-added services have some customer aspect. Consider the following as representative examples; in an electronic payment transaction processing application.
value-added processing services that are sold on a per-member/per-customer basis—e.g. network storage of card-holder security data;
special routing or logging characteristics that are negotiated individually or per customer type—e.g. stand-in processing;
service-level and availability monitoring.
   The Business Entity typically minimally includes transition notifiers for:
each BE state transition allowed by the state model (described below);
activation and deactivation of this BE on this node. (encapsulates high-availability state notification as well as teardown).

In one example, no attempt is made to make the Business Entity aware of applications. In other words, in this case, the custom application components are aware of the BE; select an appropriate BE; query the eligibility of the BE for this application; and update the BE as necessary.

The Business Entity maintains details of current state (Active, Inactive, number of available paths) as well as historical metrics. These metrics include connectivity and throughput history, for example.

Each Business Entity manages an HA partition. Higher-level components may store customer-specific mirrored data in this partition. Each Business Entity typically manages one Route and all that Route's associated endpoints. The Route state determines the customer state (more generally, the entity represented in the transaction). In one example, a Route chooses a Path based only on availability, not message content. The selection of a destination Business Entity qualifies directly to the right Endpoint for this message type, SAP notwithstanding.

A Business Entity inherits state from its Route. Activation of the configuration group will set the Business Entity up in the Initializing state; deactivation of that group will destroy the Business Entity.

The Business Entity publishes a transaction switch event for each state transition. The Business Entity type includes an abstract state notifier that allows components to register a callback for each state transition. Application services may use this callback to manage their own state both locally and cluster-wide. Setup and teardown of the Business Entity may be via configuration. The runtime state is managed by the Route. Optionally, Route administration may be wrapped as BE targets to present a coherent picture to the user.

We now discuss the message correlation component. Applications use this component to associate a set of related messages, forming a unified picture of a business transaction. For example, correlation may use various message fields to find the relationship between the messages, such as to find the relationship between a request, a response, and a reversal message for the same transaction (such as, for example, a credit transaction). The actual fields used per message may vary with the message type; this may be configurable and, in some examples, defined no earlier than message normalization or later. Message correlation is a flow component that is inserted as appropriate in an application flow by the solution/project designer.

The correlation table holds state of individual messages as the network interactions represented by those messages are pending. This managed state also includes timing; correlation may inject an event into a configured application flow when a timeout occurs.

The Channel Adaptor framework normalizes the application-channel interface. Applications may access Channel Adapter instances via the Routing service, which is in turn wrapped by the Business Entity. The Channel Adaptor framework allows an application to define its own message schemas using a message transformation language. Customization may occur on a per-channel, per-application basis. Some examples of features achieved via Channel Adaptor extension may include:
journal business messages as they touch the network;
filter and respond to channel control messages: application heartbeat, signon/signoff advice, etc.
security services: provide message confidentiality and integrity.

The correlation features may be used to assist in high availability. That is, a solution using the transaction processing platform is a distributed system with crucial in-flight data made highly available. The correlation cache maintains data for the in-flight business transactions to make that transaction data highly available. The HA characteristics fit customer environments even where there may be no control over either the connection behavior or the exchange message protocol.

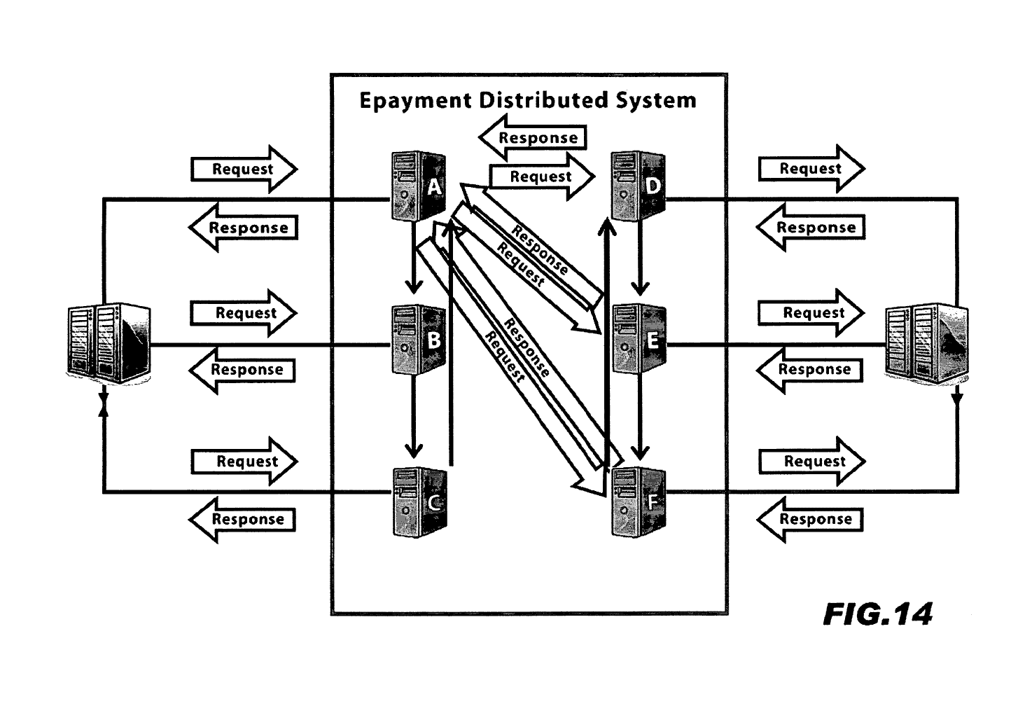

FIG. 14 shows a simplified view of a typical deployment of a transaction processing solution for illustration and discussion. The external system for business X connects to 3 nodes in the gateway: A, B, and C, while the external system for business Y connects to 3 nodes in the gateway: D, E, and F. Internally there are 3 HA partitions configured for the correlation cache for business entity X, the primary nodes are A, B, C respectively. The white arrow shows the HA primary to backup direction for the correlations, which is discussed in more detail below. So nodes A, B, and C form a cluster for business X, and nodes D, E, and F form a cluster for business Y. Requests received by node A with a destination for Business Y are sent over to node D, E, and F, and the responses come back through these nodes too, as indicated by the gray arrows. The internal traffic for node B and C is not shown. Load balancing may be achieved by the external application distributing traffic among connections to nodes, and also by the system internally distributing traffic among nodes connecting to the other business handling requests.

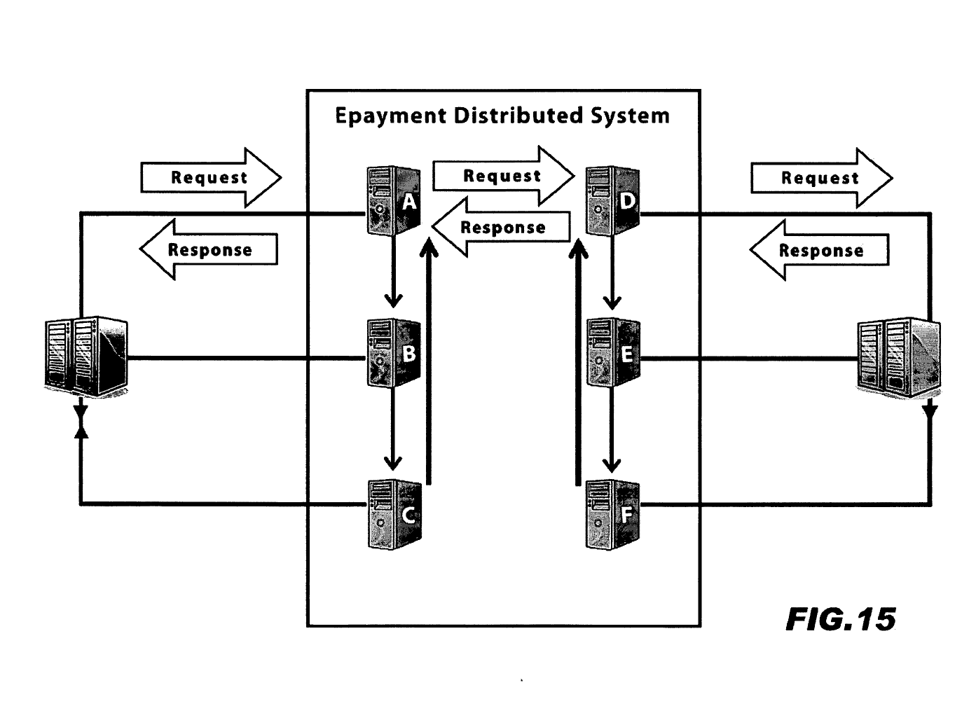

FIG. 15 shows a typical request/response pass-through scenario. Business X sends the gateway a request, which is received by node A, forwarded to node D, and sent out to Business Y. Business Y sends back a response to node D, and the response is forwarded to node A, which forwards the response to Business X. In the process the request is put on the correlation cache, and the correlation entry removed as a result of the response. This is a typical scenario, as the message flows through normally, there is no down node.

We now discuss a situation in which one of the nodes goes in the request/response path goes down. While the request is in transition, if a node goes down, the processing is similar to a situation in which a message gets lost in the network and, so, this case is typically not of much concern. If a node goes down after internal processing of a response is finished and a response is ready to be sent out, this is also similar to a situation in which a message gets lost in the network. As the latency is minimized, the window of failure narrows to its minimum during the message transition within the gateway. However, the window is wide between when the request is sent out and when the response is received back, in the above scenario, from business Y. Failure during this time may result in an inconsistent state or longer unavailability period for the system if not handled.

The correlation cache may “live” on the destination side of the request on the system, in the FIG. 15 example, node D, E, and F. For example, when node D goes down before the response comes back, the correlation cache becomes active on node E. But since the connection between node D and Y is gone (due to node D going down), Y will select another path to send back the response, and the path Y to E is just one of the possibilities. If the response comes from the path Y to F, the response may be horizontally routed to node E since E now holds the correlation cache from D. If more partitions for business Y exist, several network hops may be attempted before finding the node hosting the correlation cache.

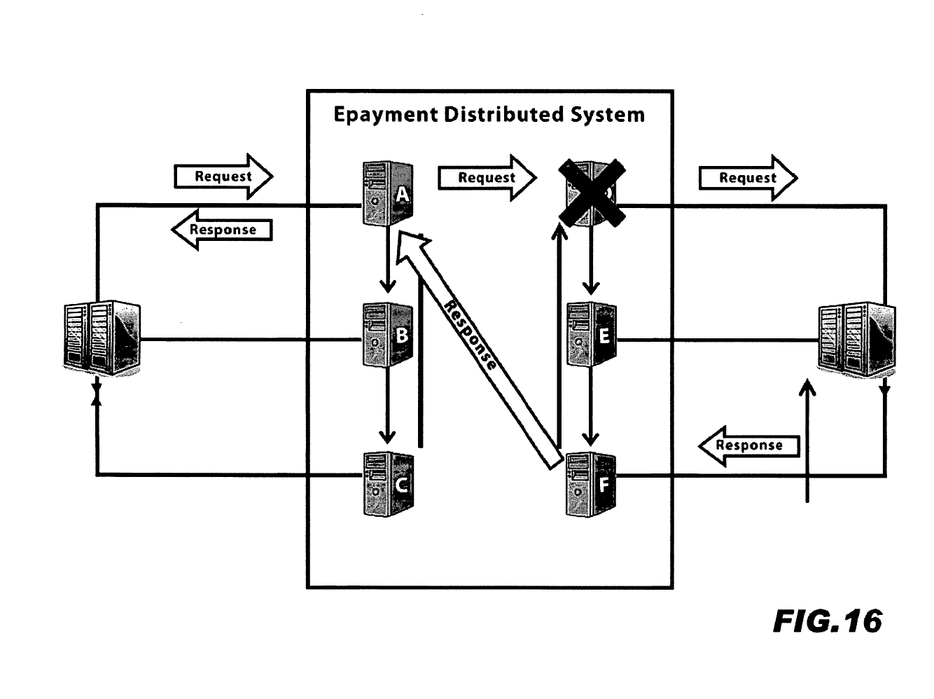

The correlation cache may “live” on the source side of the request, in the above example, node A, B, and C, and, if there is a way to figure out which partition the request has gone through from the response, then, no matter which path the response takes from Y to the gateway, either of the nodes D, E, F will be able to figure out that the response should be routed to that partition. In the above example, if D is down, the response will still go back to A, as shown in FIG. 16. If A is down, the response goes to the partition, which has become B.

We now discuss some options to figure out the request receiving partition. In accordance with a first option (Option 1—Reserved Field), a reserved field is used in the exchange message. This may not be feasible as the exchange message format may be uncontrollable. In accordance with a second option (Option 2—STAN hint), a hint is used in the STAN (System Trace Audit Number). In one example, the “mod” function of the STAN is used. For example, if the STAN assignment is to give, to each partition, STANs with equal mod, the partition can be inferred from the STAN number. For example, for four partitions—A, B, C, and D—A may be assigned a STAN of 0, 4, 8, 12, etc.; B may be assigned a STAN of 1, 5, 9, 13, and so on.

In accordance with a third option (Option 3—STAN blocks), STAN blocks are utilized and the STAN block information is distributed. For example, partition A may have a block from 1000 to 1100. In this example, every node knows that the block from 1000 to 1100 has been assigned to partition A. In accordance with a fourth option (Option 4—One partition), one partition is assigned, to be the request receiving partition, per business entity. Messages are received on multiple nodes but are all routed to the particular assigned partition. This can be useful, for example, if most of the external business applications use the connections preferentially, meaning most of the traffic go to one node normally. Even though this option may include a horizontal routing step upon incoming requests, the horizontal routing is skipped because the correlation cache will live on the preferred node.

The Business Entity class is distributed, such that the Business Entity instance “lives” on all nodes, and a downed node does not bring down the Business Entity. The Business Entity wraps up the Route class: the Business Entity is globally known, and the status is updated globally. A Business Entity has one to many correlation cache partitions, which are implemented as HA mirrored objects. A Business Entity has one STAN manager. The Business Entity is loosely coupled with the Correlation Cache and the STAN manager.

A local routing Path instance has a Channel Adaptor to handle inbound/outbound messages. A remote path passes outbound messages to the node, where the path is local. Each Channel Adaptor has one associated endpoint associated. Each endpoint has one to many sessions.

For the first three STAN options mentioned above (reserved field, STAN hint and STAN blocks), the Business Entity may have a correlation cache on each node where the external application is connected, and Responses go back to the individual correlation cache where the request is inserted. For the fourth option (one partition), in which a horizontal step is used, only one correlation cache is defined for a business entity, and all responses are routed to the correlation cache partition.

As migration is made from Internal Message Fields to Named Data Objects for messages, a set of data object is defined that each component at the solution level can agree to and can code against, instead of an unlimited list of fields. The SAPs make the conversion between protocol data and the SDU data objects. A data object may be unavailable if there is no context for it, and in some examples, more data objects are provided to meet individual project requirement. However, some fields are “hidden” by the framework and flow designers for the solutions do not need to know about them.

As discussed above, the transaction processing platform may be configured for an electronics payment solution. Data objects would be provided to deal with all message types to be handled by the epayment system. In addition to the these data objects, a control object is provided to record information about from where a request originates to where a response should be provided. In one example, the information in the epayment control object is only used at the application level, and SAPs do not need to know about this control object.

The following table lists the usages of SDU fields supported in a sample solution for authorization type of messages. SAPs are compliant with these usages. This table documents how the epayment solution may:
change the request. The epayment system may change some values before it forwards the request on.
Reject the request due to errors found.
Change the response. The epayment system may change some values before forwarding the response on.
Reject the response due to errors found.
Generate a response based on the request. The epayment system may generate a response based on an incoming request. The epayment system may generate responses in two cases, for example: when the negative file record is checked and it is appropriate to deny an authorization request, and when a request times out. When a request times out it is also possible to simply remove the correlation entry and not generate a response.
   The notations in the example presented in the table are:
E: External, value is provided in the message, by external business entity.
N: not needed. If a value is provided it is ignored.
MNP: Must Not Present.
P: Pass on.
O: Optional

TABLE 1
SDU field usage

| | Authorization Request | | Authorization Response | |
|---|---|---|---|---|
| Field Name | inbound | Outbound | Inbound | Outbound |

TypeIndicator

| | | | | |
|---|---|---|---|---|
| Version | E | N | E | N |
| MessageClass | Authorization | Authorization | Authorization | Authorization |
| MessageFunction | Request | Request | RequestResponse | RequestResponse |
| TransactionOriginator | E | N | E | N |
| FunctionCode | E | P | E | P |
| ActionCode | MNP | MNP | E | P or |
| | | | | PickUpAndDoNotHonor |

Payment

| | | | | |
|---|---|---|---|---|
| PAN | E | P | E | P |
| ProcessingCode | E | P | E | P |
| DateAndTimeTransmission | E | P | E | P |
| DateAndTimeLocalTransaction | E | P | E | P |
| STAN | E | Re-assigned | E | E |
| AcquiringInstitution | E | P | E | P |
| ForwardingInstitution | E | N | E | N |

MessageErrorIndicator

| | | | | |
|---|---|---|---|---|
| ErrorSeverityCode | MNP | O, Assigned | E, O | P or Assigned |
| MesageErrorCode | MNP | O, Assigned | E, O | P or Assigned |
| DataElementInError | MNP | O, Assigned | E, O | P or Assigned |
| DataSubelementInError | MNP | O, Assigned | E, O | P or Assigned |
| DatasetIdentifierInError | MNP | O, Assigned | E, O | P or Assigned |
| DatasetBitOrTagInError | MNP | O, Assigned | E, O | P or Assigned |

NetworkHeader

| | | | | |
|---|---|---|---|---|
| SourceId | E | P | E | P |
| Has_destinationId | E | P | E | P |
| DestinationId | E, O | P | E, O | P |
| ReservedData | E | P | E | P |

NetworkRejectHeader

| | | | | |
|---|---|---|---|---|
| RejectCode | MNP | O, FoundError | E, O | P |

The above table shows some fields may be changed by the epayment system:
ActionCode: by checking the PAN against the negative file records, if it is determined to deny an authorization request, the actionCode is populated with PickUpAndDoNotHonor.
STAN: the epayment system changes the STAN. For requests a new STAN is assigned. For responses the original STAN from the request is lost. The external business application may have a mismatch on the STAN.
MessageErrorIndicator: the epayment system may set the Message Error Indicator group to report back message errors, in which case the request or the response would be rejected and routed back to the originator.
NetworkRejectHeader: When an internal processing error happens, the NetworkRejectHeader is populated to reject the request or response.

For custom applications, it may be desired to add more data objects or data elements, for instance, the exchange messages being further parsed, if it is appropriate to do so in view of additional processing logic. The extension can live in a component other than the rudimentary epayment SDU definition package, along with the processing logic to handle the SDU extension.

We now describe some components that are provided as part of the transaction processing platform development environment. We first describe a Transaction Classifier. The transaction classifier chooses an appropriate application flow for a message. First, the transaction classifier attempts to determine if the transaction message is part of an existing business transaction. If so, the message is dispatched to an appropriate application flow for that transaction. The classifier may find no business transaction exists for that message, and route the message accordingly to an application flow. In one example, the classifier is a combination of simple flow rules.

Thus, for example, the transaction classifier component may firewall the application from the channels. For example, a Channel Adaptor may blindly drop a message on the transaction classifier and trust that it will be delivered to an appropriate application. Furthermore, a single place is provided to implement and configure the business transaction for a given application. The Transaction Classifier is a classifier, and is defined by the end-user in a flow specification.

The trace number component (also sometimes called STAN) assigns a trace number to a business transaction. In one example, the trace number is guaranteed to be unique and monotonically increasing across a cluster, with some granularity. Each Business Entity may have it own trace number “partition”.

In one example, a set of risk management components are defined. A Negative File application provides a list of accounts (more generally identifications) for which transactions should be automatically refused. This component provides the negative file lookup capability to authorization applications.

A session monitor component checks the cluster-wide state of a Business Entity on a regular basis to validate certain metrics. Each Session Monitor is configured to look after one Business Entity. The session monitor may be a global maximum session count; the monitor will check that the BE is using less than its configured maximum. Any sessions found to be over the limit will be terminated.

A journal transfer component is responsible for moving financial journals to offboard systems for archiving, viewing, etc.

Logger is a platform service that may be used by any application flow with a system-of-record logging requirement. It may also be used by SAP instances for logging at the network interface.

The Channel Adaptor framework includes built-in behavior and defined customization points (for example, the transformation service). It also defines an extensibility mechanism for specific Channel Adaptor types to add behavior.

We now describe a high-level message flow through a configured transaction processing platform. In general, an application flow can begin, for example, by a message arriving from external business entities, via a Channel Adaptor; a peer node in the cluster; or a message timeout from the correlation table.

In the case of message arrival on a channel, a special case may be made for the channel control messages. In all other cases, the start of application processing is generally the same: the message is dispatched to the transaction classifier. The transaction classifier refers to the message correlation table to determine if this message is connected with an existing business transaction. If the message is part of an existing business transaction, an application flow is selected according to the state of that business transaction, and the message is dispatched.

If the message is a new message, an application flow is selected and the message is dispatched. The application flow creates a new business transaction if one is warranted, and registers the business transaction with the message correlation table.

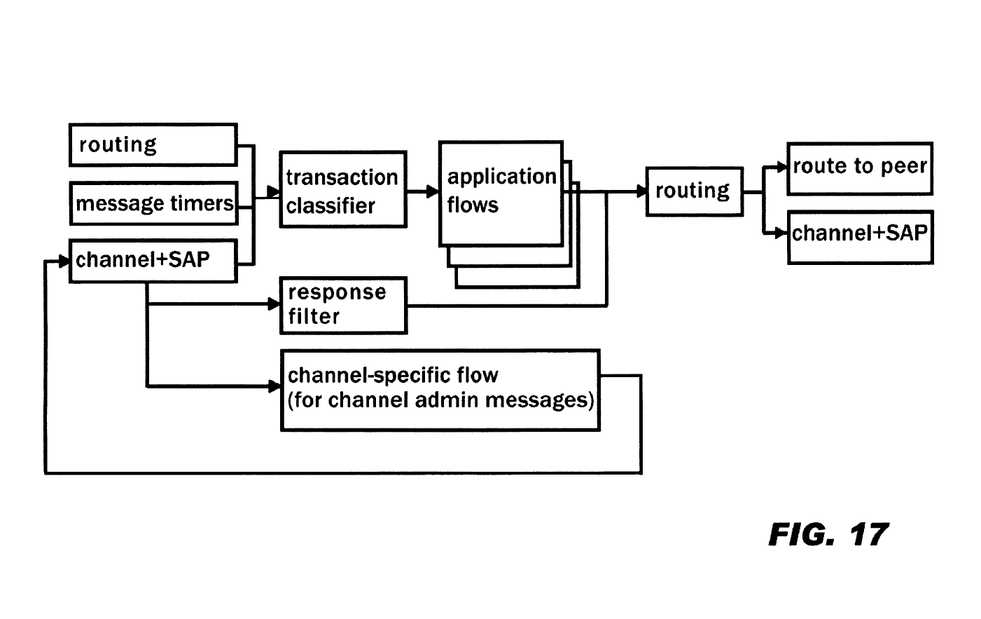

The application flow box in FIG. 17 may represent a system implemented by many individual flows—request, response, timeout, error flows. From the point of view of the transaction classifier, there is a single defined flow entry. The set of application flows may be user-extensible.

It may be noted that the distributed routing component is the only message sink—horizontal routing is encapsulated behind the general node/endpoint lookup facility.

We now discuss application error handling. When a message travels through the application flows there are a few places where the transaction may be broken up or the further processing of the message does not return the processing result. The distributed routing is such a place where there is no return from the routing. The error handling in these cases become intrinsically asynchronous, which means an error may be fed back to the application in the format of an error SDU. The SAP outbound flow feeds back any error in error SDUs. The netchannel send( ) is asynchronous and when error occurs an error message is generated and injected to the endpoint as a response. If a Channel Adaptor uses the netchannel, it transforms the netchannel error message into an Error SDU when appropriate. Channel Adaptor instances that use channels that do not generate error messages to inject them back to the application flow create the Error SDU in the specific Channel Adaptor outbound flows.

Also, since the transaction processing system is a distributed system and messages travel from node to node, there are assumptions on another node that one node cannot verify before routing a message to that node. For instance node A routes a message to node D on endpoint Dep1, but there may be a possibility that endpoint Dep1 does not exist on node D. If there is no network hop, the condition may be easily checked. But in a distributed system, the exception would be logged, the message routed back to the original node and returned back to the sender.

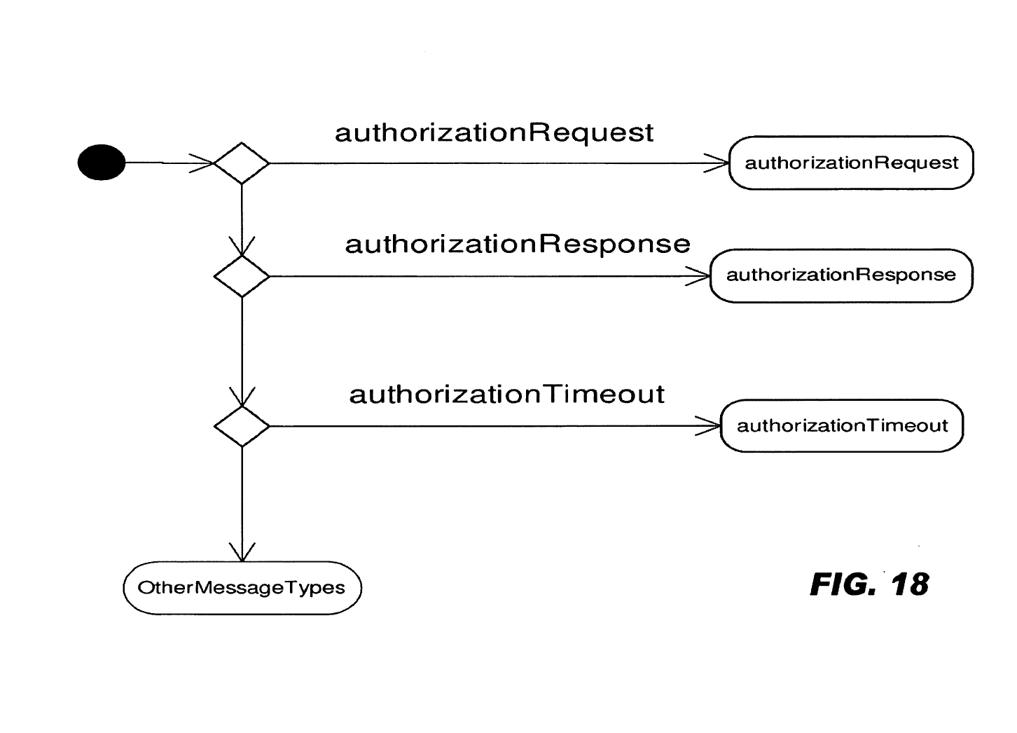

We now discuss utility flows shared by all types of messages. When we discuss flows, all flows are standard to all nodes. All flows share a classification flow such as shown in FIG. 18. Based on the message class and message function, a message type is determined and forwarded to specific handling flows. All inbound SAPs link to this flow. Internally created messages are usually injected to this flow as well. Each message type specific flow is linked after the classification flow.

The authorization flows handle all scenarios in the authorization transactions. Other message types follow a similar design to the authorization flows. The shaded modules in the figures indicate network hops.

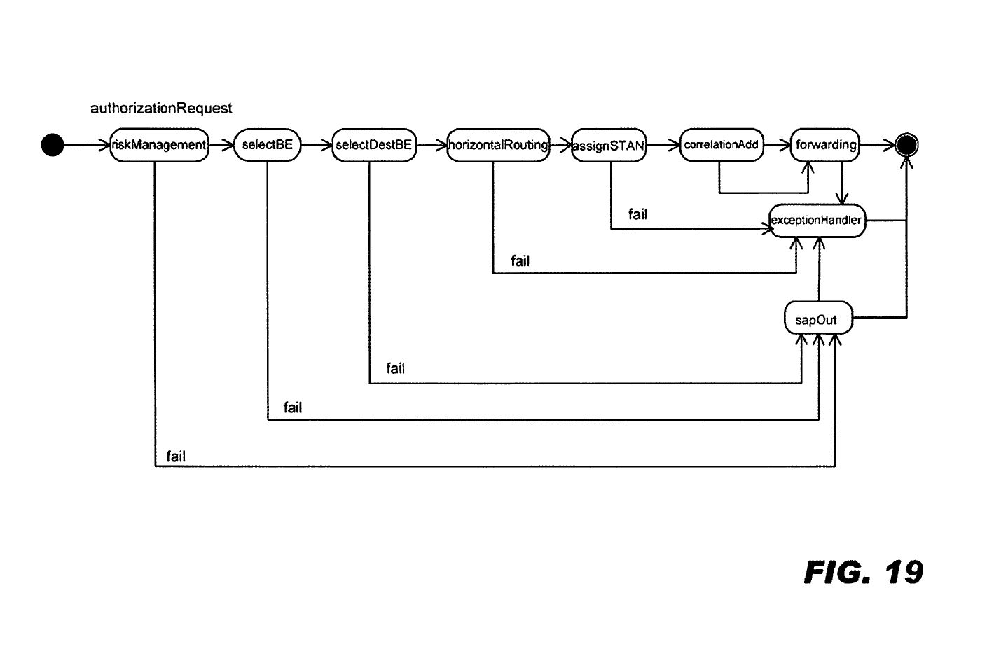

The classifier in the classification flow sends all inbound requests to the authorization request flow. This flow can be typically setup as shown in FIG. 19. In one example, the authorization requests (in this example, for an electronics payment application) go through the following steps of processing:
1. Check the negative file record to see if the primary account number (PAN) is on the black list. If no, proceed to next step. If the PAN is on the black list, turn the request into a response and send the response back to the originating SAP. This is on the local node for the request where it is received by the transaction processing system. The negative file records are distributed over to all nodes, and the negative file records become global to all nodes on the cluster. As a decision on authorization may result from this step, it may be more efficient to let the decision be made early rather than later.
2. Based on the inbound SAP instance name, the source Business Entity is determined. It is exceptional if there is no source business entity.
3. The PAN is used to determine the destination Business Entity. For example, the first 4 digits of the PAN may determine the receiving business entity of the request. If the destination business entity can not be determined, the request is rejected and sent back through the incoming SAP to the external business entity originating the request.
4. Horizontal routing. The request is horizontally routed to where the STAN is assigned and/or the correlation cache lives. This should not fail as the correlation cache and STAN manager are made highly available.
5. STAN assignment. A STAN is assigned to the request.
6. Correlation setup. An entry containing the original request is made into the correlation cache.
7. Forwarding. The request is forwarded by the routing service to a path for outbound. Usually a local path is chosen if it exists for outbound messages.

The above processing steps can be further customized to individual needs. For instance, if the horizontal routing becomes unnecessary due to application characteristics, this step may be omitted.

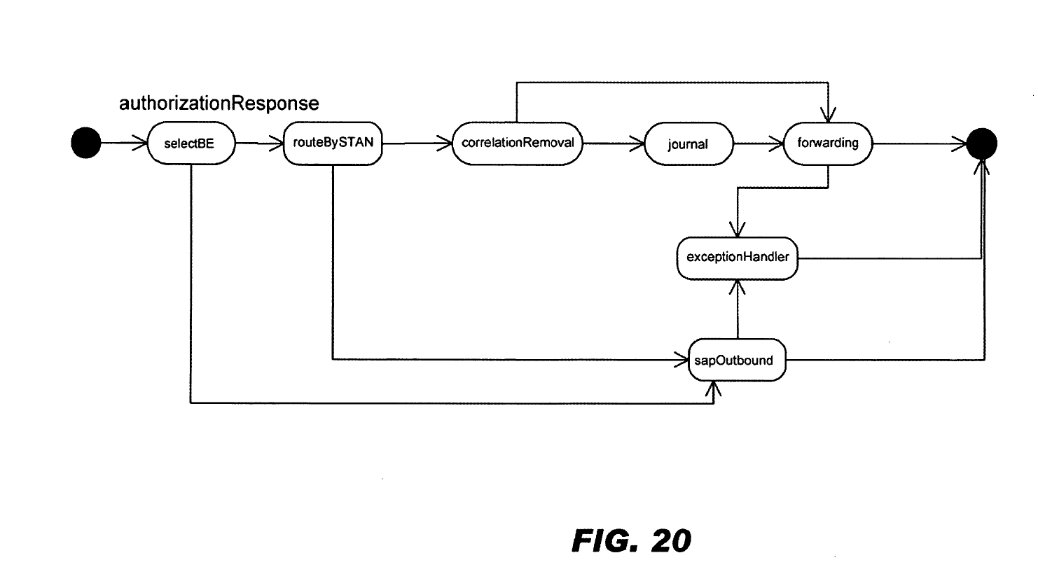

We now describe the authorization process (which is, more generally, response generation). Normally the authorization request goes to an external business and a response comes back. After the classification step, it is determined that this is a response for the authorization request, so after determining the incoming business entity, the next step is to route the response to the node where the partition for the original request lives, as described in FIG. 20. Once that node is determined, the message goes there. The steps for processing an authorization response are, in one example:
1. Determine the source business entity;
2. Route to where the correlation cache for the original request is using information contained in the response. In the sample solution, this knowledge is deduced out of the STAN.
3. Remove the correlation entry. If the correlation entry is found, remove the correlation entry and forward the message to the business entity that originated the request. If the correlation entry is not found, transform the response into rejected response, and send it back to where it comes from.
4. Write the request/response to a journal.
5. Forward the response or the rejected response as described in step 3.

As the correlation cache lives with the node where the external business sending the request is connected, the correlation cache timeout can generate a response message and inject the response message into the classification flow. The routeToSTAN step will find that the message is to be handled locally, and it goes to correlation removal, and forwarding would be local in this case too. There is no need for a dedicated flow for authorization timeout, and solutions can still configure a timeout flow if it is desired.

The transaction processing system is designed to be a high-performance system. Performance include scalability, throughput and latency. Scalability includes scaling on a single node and scaling by nodes. On a single node, the multi-core hardware architecture may be employed. On a distributed network, more nodes add to the complexity and the higher data traffic and higher CPU consumption, but each node gives more computing power and the throughput would generally improve with the number of nodes.

Throughput is affected by the amount of processing to be done.

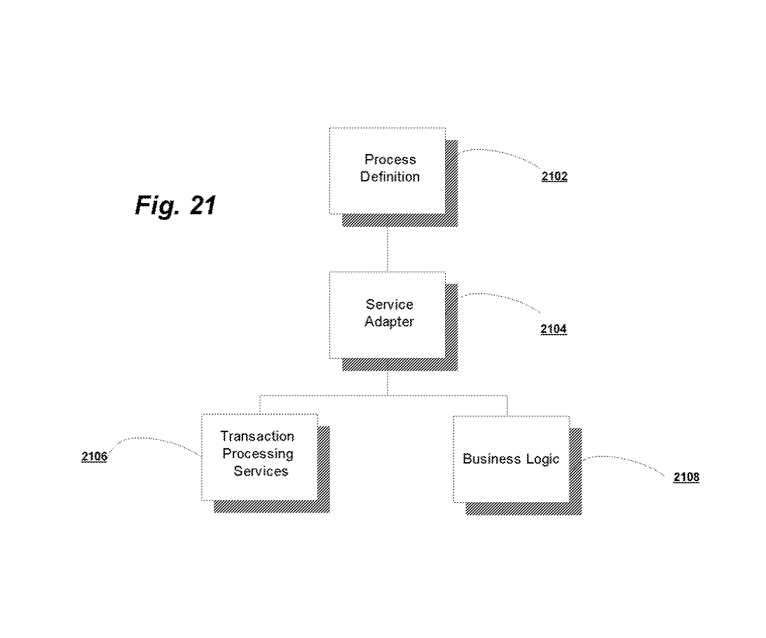

FIG. 21 schematically illustrates an example of the development methodology and environment. Referring to FIG. 21, from a process definition 2102 (business logic) of a transaction processing application, service adaptors 2104 are determined to accomplish the process. The service adaptors 2104 include transaction processing services 2106 as well as application business logic services 2108.

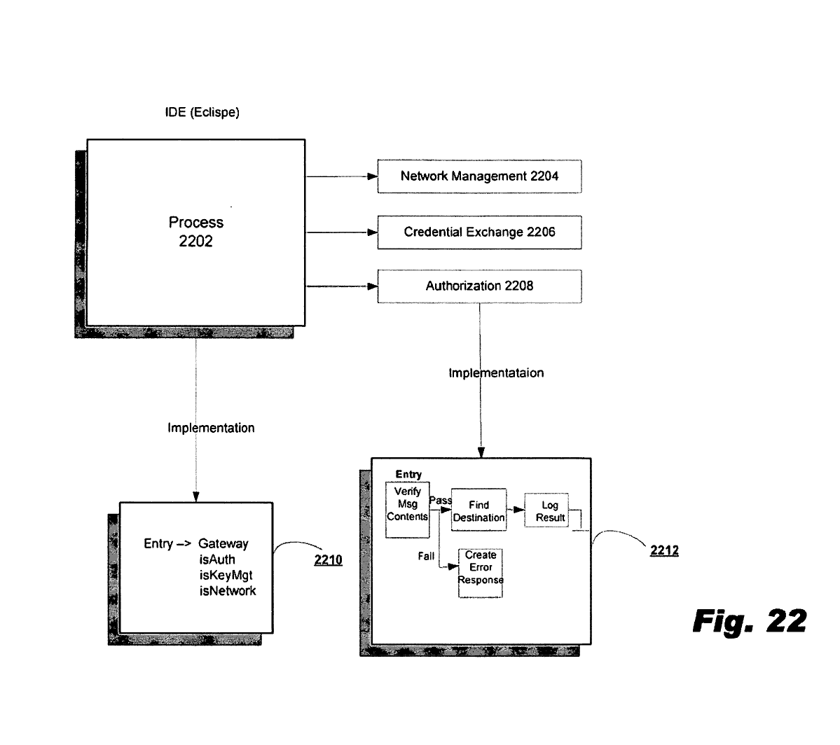

FIG. 22 shows the implementation of FIG. 21 in greater detail. In the FIG. 22 example, the development environment is based an Eclipse framework with customized plug-ins to integrate the Service Adaptors, Services and Business Logic. The process definition 2202 may be provided by a user by interacting with a set of graphical templates, an example of which will be described later. The process 2202 can be mapped to a number of service adaptors including, in the example, network management 2204, credential exchange 2206 and authorization 2208. The composition, ordering and functionality are determined by the design and purpose of the application.

The implementation of the process 2202, shown broadly by 2210 and in more detail by 2212 will ensure the resulting application is fully transactional. Referring to 2212, the implementation of the service adaptors includes the transaction services “Log Result” as an example, and also includes the business logic “Find Destination.” The resulting application (arrangement of transaction services and business logic services) is fully transactional.

“Fully transactional” means that the normal ACID properties of a transaction are preserved (Atomicity, Consistency, Isolation and Durability). With regard to atomicity, it is guaranteed that all data and events are either committed or not. It is assured that an event is delivered once and only once, as well as atomic data modifications. With regard to consistency, data consistency within a transaction is guaranteed. For example, any constraint violation (e.g. deadlock) causes all data modifications to be rolled back and all events to be replayed.

With regard to isolation, transaction isolation is provided for multiple concurrent transactions. Serializable and “dirty read” isolation semantics may be supported.

With regard to durability, once a transaction commits, the results are committed to memory. In a high-availability configuration, the data is committed to memory on two machines transactionally.

To support the ACID properties, one or more of the following features has been implemented:
concurrency using single writer, multiple reader locking.
lock promotion
deadlock detection
logging of modified object attributes
logging of events delivered in transaction

We now describe an interface to an integrated development environment (IDE) in which to develop and test transaction processing applications for a transaction processing platform. In one example, an IDE is based on Eclipse, which is a popular, extensible, open-source software development framework. The IDE is an extension of Eclipse, adding transaction platform specific features and interoperability with a transaction processing application design center.

The IDE is used to assemble a set of project elements that define the application, without the need to be concerned that the resulting application instantiation will be fully transactional. The IDE itself automatically insures that the resulting application instantiation will be fully transactional.

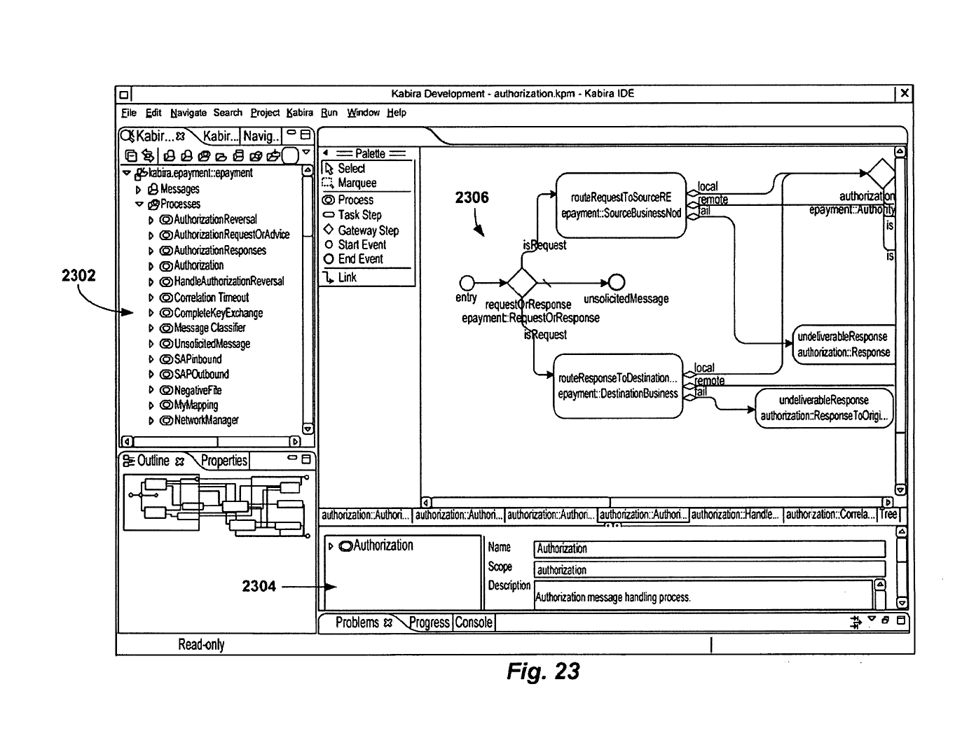

When an element is to be edited, the IDE opens the element in an appropriate editor. An example of an IDE display is provided in FIG. 23. A pane 2302 is provided to select design elements to edit. A portion 2304 of the FIG. 23 display displays the current status of builds, audits and other commands. A canvas portion 2306 graphically illustrates a currently-defined configuration of elements at some level of the application hierarchy.

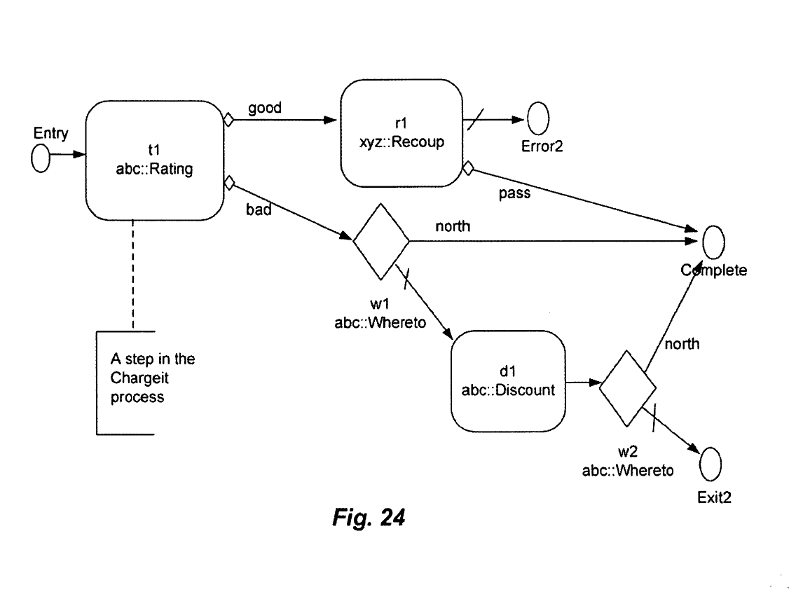

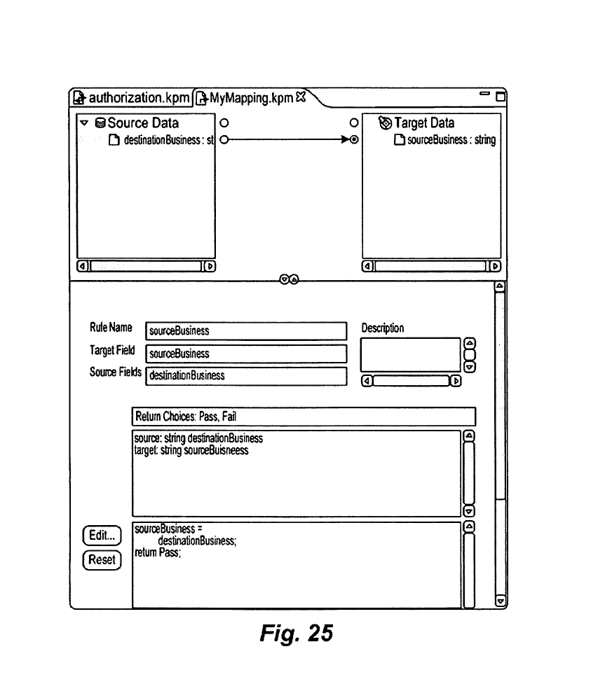

FIG. 24 illustrates an example of the canvas portion 2304 in greater detail. In particular, FIG. 24 illustrates a process diagram with three tasks and two gateways. The steps in the process are joined by links, which define the sequence in which the steps are performed. New processes may be created from scratch, or existing processes may be imported from other applications. In general, a process includes an ordered set of steps, such as tasks and gateways. A task is a piece of business logic and a gateway is a decision point. A step within a process may use some other processes defined by one or more separate process diagrams. A process used in this way is sometimes referred to as a sub-process. A gateway provides a branching point within a process, containing several gates, each of which defines one branching route from the gateway.

Steps within a business flow are linked together to specify the sequence in which the steps are performed. In one example, the following types of gateways are possible: default; unconditional (always followed); and conditional (which is followed according to occurrence of a specified condition).

As mentioned earlier, the application receives requests through channels and those requests are operated upon by business processes. A request itself is contained in a message. Messages may be made of message blocks. For example, a request to charge for a phone call may have a header block, a block to identify the caller, a block to identify the receiver of the call, and a block to identify the details of the call. The data to be stored in each of these message blocks may be defined using the IDE. Typically, each message block is defined as a data structure. A message editor may be used to define message blocks, and the message blocks grouped using message containers.

As has also been discussed earlier, channels convert data received from some external protocol into a normalized form. The IDE provides facility to graphically design mapping rules. Using the message mapping editor, message blocks may be dragged into source and target areas. The editor generates simple assignments by default, which can be customized by a user interacting with the editor. The message mapping is saved as a process by the editor, which can then be used to map message blocks anywhere in the application such as, for example, by dragging the process onto a process diagram, connecting the input and output into the process definition. FIG. 24 illustrates an example of the message mapping editor interface.

The IDE also provides facility for configuring an application using configuration files. For example, the following may be configured: inbound and outbound message routing, message processing, security, application management, and event handling. Such files may be created, imported and modified within the IDE.

We now discuss configuration of routing within a transaction processing application. A routing service is provided to determine a “best” communication path between an application and a logical destination. A routing table defines alternative paths that comprise one or more logical destinations (known as routes) and configures how to select between the paths.

Paths may be added or modified from within the IDE. Properties of paths may include name, priority (relative priority of the path), address (where messages are routed for this path), inactive path polling frequency, statistics update frequency, and description.

What is claimed is:

1. A transaction processing development methodology to employ a transaction processing development framework to facilitate development of a desired transaction processing application, comprising:
providing a plurality of service adaptors;
providing an infrastructure via which a user defined business logic of the desired transaction processing application may be provided to the transaction processing development framework;
processing the business logic definition to instantiate the transaction processing application, including to:
instantiate a subset of the service adaptors to implement services of the transaction processing application; and
arrange the instantiated service adaptors to accomplish the business logic in conjunction with generic transaction processing logic; and
guaranteeing that the arrangement of service adaptors, when executed, will accomplish the transaction processing application in a manner that is fully transactional.

2. The methodology of claim 1 wherein:
the guaranteeing is such that the service adaptors provided are sufficient to make the transaction processing application fully transactional.

3. The methodology of claim 1, further comprising:
providing a graphical user interface configured for a user to define an arrangement of elements of the business logic at various levels of a hierarchy of the transaction processing application.

4. The methodology of claim 3, wherein:
each element is selected from the group consisting at least of a task and a gateway.

5. The methodology of claim 3, wherein:
at least one of the elements is a link to a process defined by another process description.

6. The methodology of claim 3, wherein:
at least one of the elements includes a channel via which the transaction processing application is configured to receive a message representing the transaction; and
the graphical user interface is further configured for a user to define a format of the received message.

7. The methodology of claim 6, wherein:
the generic transaction logic includes logic to map the received message to a normalized protocol for processing by the instantiated transaction processing application, based on the user-defined format of the received message.

8. The methodology of claim 6, wherein:
the user-defined format of the received message includes a mapping between an external protocol of the received message and a normalized protocol for processing of the message by the instantiated transaction processing application.

9. The methodology of claim 8, wherein:
the mapping between an external protocol and a normalized protocol is at both the input and the output of a processing path of the transaction processing application.
the graphical user interface is configured for a user to define a format of the received message includes a drag and drop interface for a user to define, as the user-defined format of the received message, a mapping between an external protocol of the received message and a normalized protocol for processing of the message by the instantiated transaction processing application.

10. A computer program product for a transaction processing development methodology to employ a transaction processing development framework to facilitate development of a desired transaction processing application, the computer program product comprising at least one computer-readable medium having computer program instructions stored therein which are operable to cause at least one computing device to:
provide a plurality of service adaptors;
provide an infrastructure via which a user defined business logic of the desired transaction processing application may be provided to the transaction processing development framework;
process the business logic definition to instantiate the transaction processing application, including to:
instantiate a subset of the service adaptors to implement services of the transaction processing application; and
arrange the instantiated service adaptors to accomplish the business logic in conjunction with generic transaction processing logic; and
guarantee that the arrangement of service adaptors, when executed, will accomplish the transaction processing application in a manner that is fully transactional.

11. The computer program product of claim 10 wherein:
the guaranteeing is such that the service adaptors provided are sufficient to make the transaction processing application fully transactional.

12. The computer program product of claim 10, wherein the computer program instructions stored therein are further operable to cause at least one computing device to:
provide a graphical user interface configured for a user to define an arrangement of elements of the business logic at various levels of a hierarchy of the transaction processing application.

13. The computer program product of claim 12, wherein:
each element is selected from the group consisting at least of a task and a gateway.

14. The computer program product of claim 12, wherein:
at least one of the elements is a link to a process defined by another process description.

15. The computer program product of claim 12, wherein:
at least one of the elements includes a channel via which the transaction processing application is configured to receive a message representing the transaction; and
the graphical user interface is further configured for a user to define a format of the received message.

16. The computer program product of claim 15, wherein:
generic transaction logic includes logic to map the received message to a normalized protocol for processing by the instantiated transaction processing application, based on the user-defined format of the received message.

17. The computer program product of claim 15, wherein:
the user-defined format of the received message includes a mapping between an external protocol of the received message and a normalized protocol for processing of the message by the instantiated transaction processing application.

18. The computer program product of claim 17, wherein:
the mapping between an external protocol and a normalized protocol is at both the input and the output of a processing path of the transaction processing application.
the graphical user interface is configured for a user to define a format of the received message includes a drag and drop interface for a user to define, as the user-defined format of the received message, a mapping between an external protocol of the received message and a normalized protocol for processing of the message by the instantiated transaction processing application.

19. A computing system including at least one computing device, configured to provide user assistance functionality associated with an application, the at least one computing device configured to:
provide a plurality of service adaptors;
provide an infrastructure via which a user defined business logic of the desired transaction processing application may be provided to the transaction processing development framework;
process the business logic definition to instantiate the transaction processing application, including to:
instantiate a subset of the service adaptors to implement services of the transaction processing application; and
arrange the instantiated service adaptors to accomplish the business logic in conjunction with generic transaction processing logic; and
guarantee that the arrangement of service adaptors, when executed, will accomplish the transaction processing application in a manner that is fully transactional.

20. The computing system of claim 19 wherein:
the guaranteeing is such that the service adaptors provided are sufficient to make the transaction processing application fully transactional.

21. The computer program product of claim 19, wherein the computer program instructions stored therein are further operable to cause at least one computing device to:
provide a graphical user interface configured for a user to define an arrangement of elements of the business logic at various levels of a hierarchy of the transaction processing application.
